(19) United States
(12) Patent Application Publication
(10) Pub. No.: US 2011/0238391 A1
(43) Pub. Date: Sep. 29, 2011

(54) ION IMPLANTATION DISTRIBUTION GENERATION METHOD AND SIMULATOR

(75) Inventor: Kunihiro Suzuki, Kawasaki (JP)

(73) Assignee: FUJITSU LIMITED, Kawasaki-shi (JP)

(21) Appl. No.: 13/052,612

(22) Filed: Mar. 21, 2011

(30) Foreign Application Priority Data
Mar. 26, 2010 (JP) 2010-073364

(51) Int. Cl. G06F 17/10

(52) U.S. Cl. 703/2

(57) ABSTRACT

An ion implantation distribution generation method for causing a computer to generate an ion implantation distribution, the method causing the computer to perform: generating distributions related to Rₚ lines each representing a range projection Rₚ in a surface subjected to ion implantation in a device structure of a semiconductor integrated circuit; drawing the Rₚ lines on a two-dimensional diagram corresponding to an ion implantation condition; and generating, for each of the Rₚ lines, a two-dimensional impurity concentration distribution in accordance with two-dimensional vector coordinates provided to the Rₚ line.

### CROSS REFERENCE TO RELATED APPLICATION

This application is based upon and claims the benefit of priority from the prior Japanese Patent Application NO. 2010-073364 filed on Mar. 26, 2010, the entire contents of which are incorporated herein by reference.

### FIELD

The embodiments discussed herein are related to an ion implantation distribution generation method and a simulator.

### BACKGROUND

In the development of state-of-the-art MOSFETs (Metal Oxide Semiconductor Field Effect Transistors) for LSI (Large-Scale Integration), accurate prediction, by simulation, of an ion implantation distribution in a MOS structure has become considerably important in recent years in terms of evaluation of electrical characteristics.

For example, there have been proposed a method of performing accuracy fitting between the theoretical value of the standard deviation of variations in the depth direction caused by changes in ion incident angle and the experimental value obtained by SIMS (Secondary Ion Mass Spectroscopy) with the use of the standard deviation of variations in the transverse direction as a fitting parameter, to thereby empirically identity the standard deviation in the transverse direction, and a method of simulating the ion implantation distribution in the MOS structure with the use of a simple analysis model using such a standard deviation in the transverse direction (see Japanese Laid-open Patent Publication No. 2000-138178 and Suzuki K., Tanabe R., and Kojima S., “Analytical Model for Two-Dimensional Ion Implantation Profile in MOS-Structure Substrate,” IEEE Trans. Electron Devices, Vol. ED-56, No. 12, pages 3083 to 3089, 2009, for example).

Other related art includes: Hisamoto D., Lee W.-C., Kedzierski J., Takeuc hi H., Asano K., Kuo C., Anderson E., King T.-J., Bokor J., and Hu C., “FinFET-A Self-Aligned Double-Gate MOSFET Scalable to 20 nm,” IEEE Trans. Electron Devices, Vol. ED-47, No. 12, pages 2320 to 2325, 2000; Ryu S.-W., Han J.-W., Kim C.-J., and Choi Y.-K., “Investigation of Isolation-Dielectric Effects of PDSOI FinFET on Capacitorless 1T-DRAM,” IEEE Trans. Electron Devices, Vol. ED-56, No. 12, pages 3232 to 3235, 2009; Wada T. and Kotani N., “Design and Development of 3-Dimensional Process Simulator,” IEICE. Trans. Electron, Vol. E82-C, No. 6, pages 839 to 847, 1999; and Ohkura Y., Suzuki C., Mise N., Matsuki T., Eimori T., and Nakamura M., “Monte Carlo Investigation of Potential Fluctuation in 3D Device Structure,” Semiconductor Leading Edge Technologies, [online], Sep. 9, 2008 (retrieved from <http://www.selete.co.jp/?lang=EN&act=Research&sel_no=103> on The Internet on Feb. 24, 2010).

The above-described related art is advantageous in that the introduction of an analysis model into the simulation of a two-dimensional ion implantation distribution allows a reduction in calculation time, as compared with the simulation based on numerical calculation, and that the physical image of the MOS structure is easily grasped. In terms of the model to be incorporated into a device simulator, however, the related art has an issue in that, if the obtained shape deviates from a similar figure, a new model needs to be derived and incorporated into the simulator every time the deviation occurs.

For example, in a transistor device having a three-dimensional structure, such as FinFET (Fin Field Effect Transistor) which has attracted attention in recent years, the analysis model and the numerical calculation are complicated, and it is not easy to perform simulation of a three-dimensional ion implantation distribution.

### SUMMARY

According to one aspect of the embodiments, there is an ion implantation distribution generation method for causing a computer to generate an ion implantation distribution. The method is configured to cause the computer to perform, the method including: generating distributions related to Rₚ lines each representing a range projection Rₚ in a surface subjected to ion implantation in a device structure of a semiconductor integrated circuit, drawing the Rₚ lines on a two-dimensional diagram corresponding to an ion implantation condition, and agenerating, for each of the Rₚ lines, a two-dimensional impurity concentration distribution in accordance with two-dimensional vector coordinates provided to the Rₚ line.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is an impurity concentration distribution diagram illustrating, for each step, the distribution of ion implantation in a MOSFET accompanying pocket ion implantation;

FIGS. 2A to 2C are explanatory diagrams of a pocket ion implantation process;

FIG. 3 is an explanatory diagram of an ion implantation state in a region a₁;

FIG. 4 is an explanatory diagram of variable transformation for performing coordinate transformation;

FIG. 5 is an explanatory diagram of an ion implantation state in a region a₂;

FIG. 6 is an explanatory diagram of an ion implantation state in a region b;

FIG. 7 is a diagram illustrating compassion of analysis models of two-dimensional concentration distribution;

FIGS. 8A and 8B are diagrams illustrating compassions, in a longitudinal distribution and a transverse distribution, of the two-dimensional ion implantation distributions illustrated in FIG. 7;

FIG. 9 is a diagram illustrating comparison of a simplified analysis model and an analysis model in terms of a current characteristic;

FIG. 10 is a diagram illustrating comparison of the simplified analysis model and the analysis model in terms of gate length dependence of a threshold voltage;

FIG. 11 is a diagram illustrating comparison of transverse distributions obtained with various ΔRₚₜ values;

FIG. 12 is a diagram illustrating semi-infinite Rₚ lines;

FIG. 13 is a diagram illustrating the definition of the Rₚ line;

FIGS. 14A to 14D are diagrams for explaining the types of the Rₚ line in a horizontal direction s;

FIG. 15 is a bird's-eye view of a FinFET;

FIG. 16 is a diagram for explaining the definition of rotation angles for ion implantation into the FinFET;

FIG. 17 is a diagram illustrating an example of Rₚ lines for a rotation angle of 90°;

FIG. 18 is a diagram illustrating an example of Rₚ lines for a rotation angle of 0°;

FIGS. 19A and 19B are diagrams illustrating two-dimensional impurity concentration distributions on the xy-plane at an end of a gate;

FIGS. 20A and 20B are diagrams each illustrating a one-dimensional cut concentration distribution of a cross section of the two-dimensional impurity concentration distribution in FIG. 19A obtained by the use of the simplified analysis model;

FIGS. 21A and 21B are diagrams illustrating two-dimensional impurity concentration distributions on the zy-plane of the FinFET illustrated in FIG. 15;

FIGS. 22A and 22B are top views illustrating two-dimensional impurity concentration distributions on the zx-plane of the FinFET illustrated in FIG. 15 at a depth y of H−Rₚ cos α;

FIG. 23 is a diagram illustrating a one-dimensional cut concentration distribution of a cross section of the two-dimensional impurity concentration distribution of FIG. 22A obtained by the use of the simplified analysis model;

FIG. 24 is a diagram illustrating a hardware configuration of a simulator;

FIG. 25 is a diagram illustrating a functional configuration example of the simulator; and

FIG. 26 is a diagram for explaining a calculation process of the impurity concentration distribution in a packet region using the simplified analysis model.

### DESCRIPTION OF EMBODIMENTS

Embodiments of the present invention will be described below on the basis of the drawings. Description will be first made of the impurity concentration distribution in each of the steps of an ion implantation process.

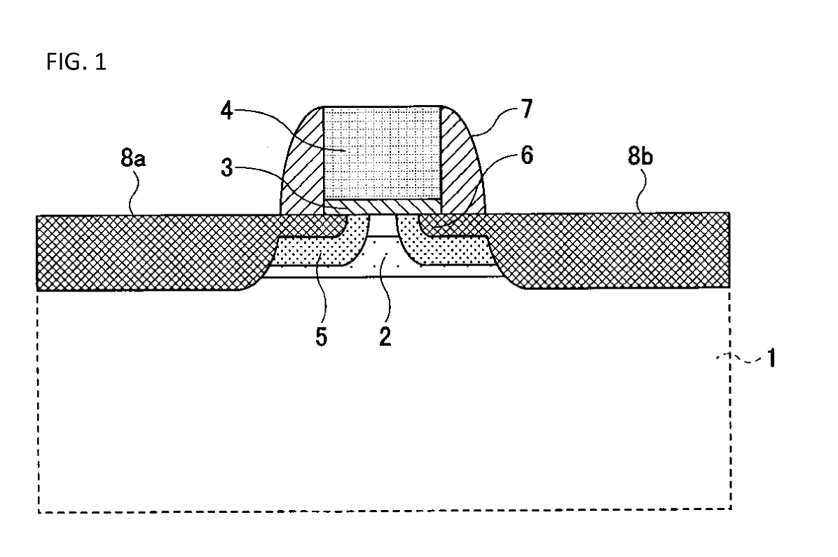

Assumption: FIG. 1 is an impurity concentration distribution diagram illustrating, for each of the steps, the distribution of ion implantation in a MOSFET accompanying pocket ion implantation. The drawing herein illustrates an example of performing channel ion implantation on a substrate 1 to form a channel-doped region 2 (first and second steps), forming a gate insulating film 3 and a gate electrode 4 and implanting ions at a high tilt angle to form a pocket region 5 (third step), and forming an extension region 6 and thereafter a side wall 7 and then forming a source region 8a and a drain region 8b (fourth step).

(First Step) Substrate: The impurity concentration distribution is represented by the following formula (1) on the assumption that the concentration is constant.

N₁(x,y)=N_{sub} N₀(x,y)=N_{sub} (1)

(Second Step) Channel Ion Implantation Distribution: The channel ion implantation is performed on the entire surface of the substrate not formed with a gate electrode. The impurity concentration distribution is, therefore, represented by the following formula (2).

$${N}_{1} ( x , y ) = \frac{Φ}{\sqrt{2 π} Δ {R}_{p}} exp [ - \frac{{( y - {R}_{p} )}^{2}}{2 Δ {R}_{p}^{2}} ] \qquad ( 2 )$$

(Third Step) Extension Region Ion Implantation Distribution: The impurity concentration distribution is represented by the following formula (3) on the assumption that a gate electrode having a length L_{G} has been formed.

$${N}_{2} ( x , y ) = [ 1 - \frac{erf ( \frac{\frac{{L}_{G}}{2} - x}{\sqrt{2} Δ {R}_{pt}} ) + erf ( \frac{\frac{{L}_{G}}{2} + x}{\sqrt{2} Δ {R}_{pt}} )}{2} ] \frac{Φ}{\sqrt{2 π} Δ {R}_{p}} exp [ - \frac{{( y - {R}_{p} )}^{2}}{2 Δ {R}_{p}^{2}} ] \qquad ( 3 )$$

(Fourth Step) Source and Drain Region Ion Implantation Distribution: Further, the impurity concentration distribution is represented by the following formula (4) on the assumption that a side wall having a thickness L_{side} has been formed on both sides of the gate electrode.

$${N}_{3} ( x , y ) = [ 1 - \frac{erf ( \frac{\frac{{L}_{G} + 2 {L}_{side}}{2} - x}{\sqrt{2} Δ {R}_{pt}} ) + erf ( \frac{\frac{{L}_{G} + 2 {L}_{side}}{2} + x}{\sqrt{2} Δ {R}_{pt}} )}{2} ] \frac{Φ}{\sqrt{2 π} Δ {R}_{p}} exp [ - \frac{{( y - {R}_{p} )}^{2}}{2 Δ {R}_{p}^{2}} ] \qquad ( 4 )$$

Herein, φ, Rₚ, ΔRₚ, and ΔRₚₜ in each of the formulae respectively represent the dose, the range projection, the straggling of the range projection in a longitudinal direction, and the straggling of the range projection in a transverse direction in each ion implantation condition.

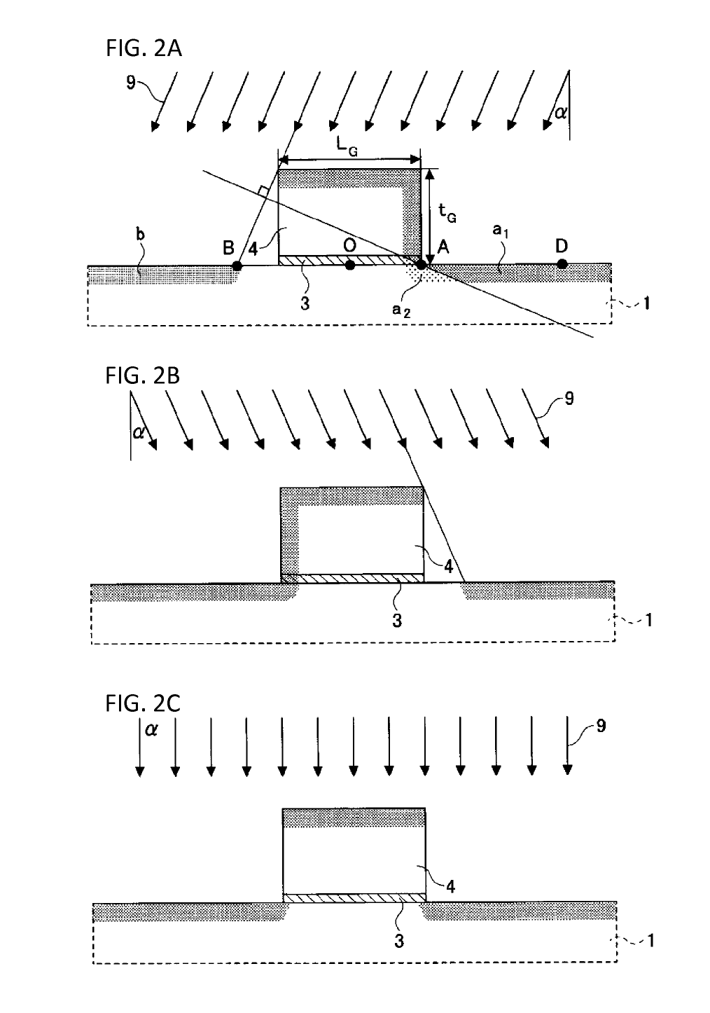

Further, a fifth step corresponds to the pocket ion implantation process. The pocket ion implantation process includes the steps illustrated in FIGS. 2A to 2C. FIGS. 2A to 2C are explanatory diagrams of the pocket ion implantation process. A MOS-structure substrate having a gate length L_{G} and a gate height t_{G} is exemplified in FIGS. 2A to 2C.

In general, the pocket ion implantation is performed in four directions, as illustrated in the drawings, to maintain symmetry. The pocket ion implantation is performed while the substrate is rotated around the center of the surface thereof as an axis, and the four directions are determined by, for example, rotation angles of 0°, 90°, 180°, and 270°. That is, as illustrated in FIG. 2A, the first ion implantation is performed on the substrate 1 at a tilt angle α from the right side of the gate electrode 4 with a rotation angle of 90°. In the region on the right side of the gate electrode 4, ions are implanted into a side wall of the gate electrode 4 and the substrate 1.

In this case, the analysis is separately performed on a region a₁ in which the concentration is determined independently of the presence or absence of the gate electrode 4, and a region a₂ in which the concentration is affected by the side wall of the gate electrode 4. The regions a₁ and a₂ are represented as ion implantation regions divided by a straight line perpendicular to the tilt angle α and passing through a connection point A of the side wall of the gate electrode 4 and the surface of the substrate 1.

On the left side of the gate electrode 4, there are a region blocked by the gate electrode 4 and thus not subjected to the ion implantation and a region b subjected to the ion implantation (hereinafter referred to as the region b subjected to shadowing by the gate electrode 4). The region b is represented as an ion implantation region extending in a direction away from the gate electrode 4 from an intersection point B at which the surface of the substrate 1 intersects with a straight line extending at the tilt angle α from a top portion of a side wall of the gate electrode 4. Strictly speaking, some components of ion beams 9 pass through the top portion of the gate electrode 4 and reach the substrate 1. In the following, however, such components will be ignored, and the gate electrode 4 will be assumed to completely block the ion beams 9 in the above-described region.

Then, as illustrated in FIG. 2B, the second ion implantation is performed on the substrate 1 from the left side of the gate electrode 4 with a rotation angle of 270°. The distribution obtained in this case is symmetrical, with respect to the center of the gate electrode 4 as an axis, with the distribution obtained by the ion implantation performed from the right side.

Further, FIG. 2C illustrates an example of the third ion implantation performed on the substrate 1 at the tilt angle α with a rotation angle of 0°, and an example of the fourth ion implantation performed on the substrate 1 at the tilt angle α with a rotation angle of 180°. These examples are simply treated as the combination of the distribution on an infinite plane and the distribution in the transverse direction, which are already known.

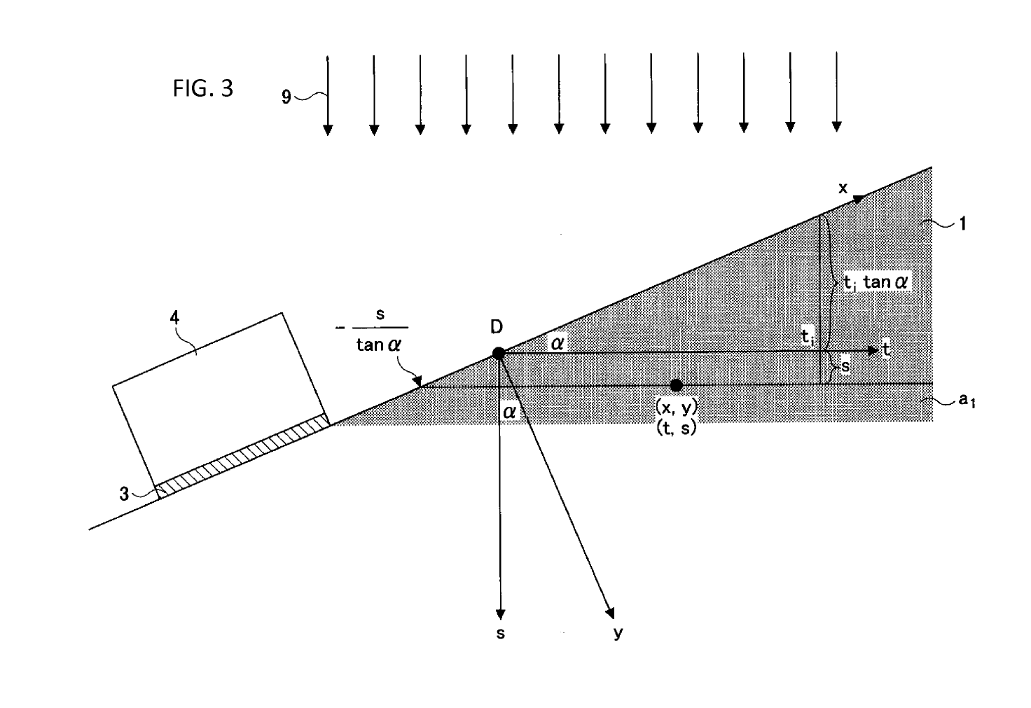

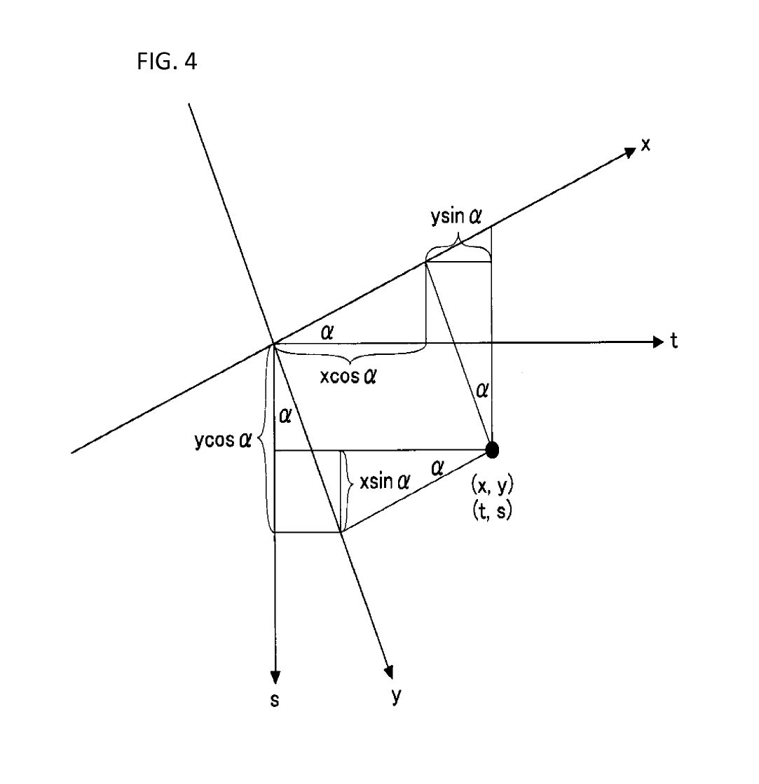

The region a₁ will be first examined with reference to FIGS. 3 and 4. The dose φ described in the following is defined as the dose for a surface perpendicular to the beam axis. The coordinates with reference to the beam axis and the coordinates with reference to the substrate surface will be represented as (t, s) and (x, y), respectively. As described later, the impurity concentration in the region is independent of x, and is represented by a function including only y. Thus, the position of the origin D is set for convenience, and may be set to an arbitrary position.

For graphical clarification, the origin D is herein set to a position far from an end of the gate electrode 4, as illustrated in FIG. 3. The impurity concentration distribution N₄_{_{—}}_{R90}(t, s) at the position (t, s) is considered to be the sum of the respective contributions to the position (t, s) of the ions implanted into a region corresponding to at value of t and the ions implanted into a region corresponding to at value of tᵢ+dtᵢ. As illustrated in the drawing, tᵢ is assumed to range from −s/tan α corresponding to an end portion of the surface of the substrate 1 to an infinite value at the right end. Therefore, the impurity concentration distribution may be represented by the following formula (5).

$$\begin{matrix}{N}_{4 \_ R 90 \_ {a}_{1}} ( t , s ) = Φ {\int }_{- s / tan α}^{∞} \frac{1}{\sqrt{2 π} Δ {R}_{p}} exp [ - \frac{{( s + {t}_{i} tan α - {R}_{p} )}^{2}}{2 Δ {R}_{p}^{2}} ] \\ \frac{1}{\sqrt{2 π} Δ {R}_{pt}} exp [ - \frac{{( t - {t}_{i} )}^{2}}{2 Δ {R}_{pt}^{2}} ] d {t}_{i} \\ = \{ \frac{1}{2} + \frac{1}{2} erf [ \begin{matrix}\frac{1}{\sqrt{2} {σ}_{1} Δ {R}_{p} Δ {R}_{pt}} \\ ( \begin{matrix}s Δ {R}_{p}^{2} \frac{cos α}{tan α} + t Δ {R}_{p}^{2} cos α + \\ {R}_{p} Δ {R}_{pt}^{2} sin α\end{matrix} )\end{matrix} ] \} \times \\ \frac{Φ cos α}{\sqrt{2 π} {σ}_{1}} exp [ - \frac{{[ ( s - {R}_{p} ) cos α + t sin α ]}^{2}}{2 {σ}_{1}^{2}} ]\end{matrix} \qquad ( 5 )$$

In the formula (5), erf( ) represents an error function. Herein, the following equation holds.

σ₁²=ΔRₚ² cos²α+ΔRₚₜ² sin² α (6)

Herein, variable transformation is performed by reference to FIG. 4.

Thereby, the following equations are derived.

$$\{ \begin{matrix}t = x cos α + y sin α \\ s = y cos α - x sin α\end{matrix} \qquad ( 7 )$$

The above-described formula (5) is, therefore, represented by the following formula (8), which uses a function including only y, as described above.

$${N}_{4 \_ R 90 \_ {a}_{1}} ( x , y ) = \{ \frac{1}{2} + \frac{1}{2} erf [ \frac{\frac{y Δ {R}_{p}^{2}}{tan α} + {R}_{p} Δ {R}_{pt}^{2} sin α}{\sqrt{2} {σ}_{1} Δ {R}_{p} Δ {R}_{pt}} ] \} \times \frac{Φ cos α}{\sqrt{2 π} {σ}_{1}} exp [ - \frac{{( y - {R}_{p} cos α )}^{2}}{2 {σ}_{1}^{2}} ] \qquad ( 8 )$$

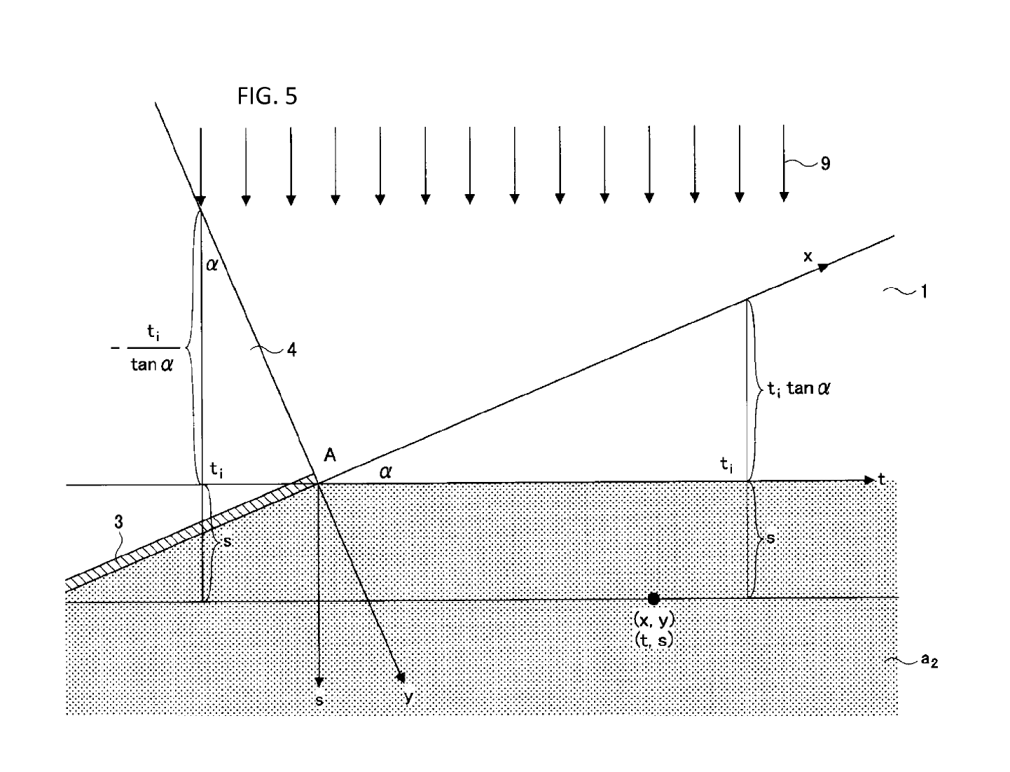

Subsequently, the region a₂ will be examined with reference to FIG. 5. The impurity concentration at the position (t, s) in the region is affected by the gate electrode 4. The gate electrode 4, which in fact has a finite height, is assumed herein to have an infinite height. When the height of the gate electrode 4 exceeds a predetermined value, the impurity concentration related to the gate electrode 4 may be ignored, if the ion beams 9 reach the surface of the substrate 1. Therefore, this is reasonable approximation.

Herein, the origin is set to an end A of the gate. By reference to FIG. 5, the following formula (9) is derived.

$${N}_{4 \_ R 90 \_ {a}_{2}} ( t , s ) / Φ = {\int }_{- ∞}^{0} \frac{1}{\sqrt{2 π} Δ {R}_{p}} exp [ - \frac{{( s - \frac{{t}_{i}}{tan α} - {R}_{p} )}^{2}}{2 Δ {R}_{p}^{2}} ] \frac{1}{\sqrt{2 π} Δ {R}_{pt}} exp [ - \frac{{( t - {t}_{i} )}^{2}}{2 Δ {R}_{pt}^{2}} ] d {t}_{i} + {\int }_{0}^{∞} \frac{1}{\sqrt{2 π} Δ {R}_{p}} exp [ - \frac{{( s + {t}_{i} tan α - {R}_{p} )}^{2}}{2 Δ {R}_{p}^{2}} ] \frac{1}{\sqrt{2 π} Δ {R}_{pt}} exp [ - \frac{{( t - {t}_{i} )}^{2}}{2 Δ {R}_{pt}^{2}} ] d {t}_{i} \qquad ( 9 )$$

The first term of the formula (9) is affected by the side wall of the gate electrode 4, while the second term of the formula (9) is unaffected by the gate electrode 4.

The formula (9) is similarly subjected to the variable transformation, and is represented by the following formula (10).

$${N}_{4 \_ R 90 \_ {a}_{2}} ( x , y ) = \{ \frac{1}{2} - \frac{1}{2} erf [ \frac{y {σ}_{2}^{2} - {R}_{p} Δ {R}_{pt}^{2} cos α - x ( Δ {R}_{pt}^{2} - Δ {R}_{p}^{2} ) sin α cos α}{\sqrt{2} {σ}_{2} Δ {R}_{p} Δ {R}_{pt}} ] \} \times \frac{Φ sin α}{\sqrt{2 π} {σ}_{2}} exp [ - \frac{{( x + {R}_{p} sin α )}^{2}}{2 {σ}_{2}^{2}} ] + \{ \frac{1}{2} + \frac{1}{2} erf [ \frac{x {σ}_{1}^{2} + {R}_{p} Δ {R}_{pt}^{2} sin α + y ( Δ {R}_{p}^{2} - Δ {R}_{pt}^{2} ) sin α cos α}{\sqrt{2} {σ}_{1} Δ {R}_{p} Δ {R}_{pt}} ] \} \times \frac{Φ cos α}{\sqrt{2 π} {σ}_{1}} exp [ - \frac{{( y - {R}_{p} cos α )}^{2}}{2 {σ}_{1}^{2}} ] \qquad ( 10 )$$

Herein, the following equation holds.

σ₂²=ΔRₚ² sin²α+ΔRₚₜ² cos² α (11)

Then, evaluation is performed on the formula (10) on the border y=x·tan α between the regions a₁ and a₂. The second term of the formula (10) represents the contribution by the gate pattern region. Thus, only the first term may be taken into account. If y=x·tan α is substituted into the first term of the formula (10) to eliminate x, the following formula (12) is derived.

$${N}_{4 \_ R 90 \_ {a}_{2}} ( x , y ) = \{ \frac{1}{2} + \frac{1}{2} erf [ \frac{\frac{y}{tan α} {σ}_{1}^{2} + {R}_{p} Δ {R}_{pt}^{2} sin α + y ( Δ {R}_{p}^{2} - Δ {R}_{pt}^{2} ) sin α cos α}{\sqrt{2} {σ}_{1} Δ {R}_{p} Δ {R}_{pt}} ] \} \times \frac{Φ cos α}{\sqrt{2 π} {σ}_{1}} exp [ - \frac{{( y - {R}_{p} cos α )}^{2}}{2 {σ}_{1}^{2}} ] \qquad ( 12 )$$

The difference between the formula (12) and the foregoing formula (8) is in the numerator. If the numerator of the formula (12) is calculated, therefore, the calculation result matches the numerator of the formula (8), as illustrated in the following formula (13).

$$\frac{y}{tan α} {σ}_{1}^{2} + {R}_{p} Δ {R}_{pt}^{2} sin α + y ( Δ {R}_{p}^{2} - Δ {R}_{pt}^{2} ) sin α cos α = \frac{y}{tan α} ( Δ {R}_{p}^{2} {cos}^{2} α + Δ {R}_{pt}^{2} {sin}^{2} α ) + y ( Δ {R}_{p}^{2} - Δ {R}_{pt}^{2} ) sin α cos α + {R}_{p} Δ {R}_{pt}^{2} sin α = \frac{y}{sin α} ( Δ {R}_{p}^{2} {cos}^{3} α + Δ {R}_{pt}^{2} {sin}^{2} α cos α ) + \frac{y}{sin θ} ( Δ {R}_{pt}^{2} {sin}^{2} α cos α - {sin}^{2} α cos α Δ {R}_{pt}^{2} ) + {R}_{p} Δ {R}_{pt}^{2} sin α = \frac{y}{sin α} [ Δ {R}_{pt}^{2} ( {cos}^{3} α + {sin}^{2} α cos α ) + Δ {R}_{pt}^{2} ( {sin}^{2} α cos α - {sin}^{2} α cos α ) ] + {R}_{p} Δ {R}_{pt}^{2} sin α = \frac{y}{tan α} Δ {R}_{p}^{2} + {R}_{p} Δ {R}_{pt}^{2} sin α \qquad ( 13 )$$

Herein, if the origin is shifted from the end of the gate to the center of the gate with a change from x to x−L_{G}/2 in the formula (10), the following formula (14) is obtained.

$${N}_{4 \_ R 90 \_ {a}_{2}} ( x , y ) = \{ \frac{1}{2} - \frac{1}{2} erf [ \frac{\begin{matrix}y {σ}_{2}^{2} - {R}_{p} Δ {R}_{pt}^{2} cos α - \\ ( x - \frac{{L}_{G}}{2} ) ( Δ {R}_{pt}^{2} - Δ {R}_{p}^{2} ) sin α cos α\end{matrix}}{\sqrt{2} {σ}_{2} Δ {R}_{p} Δ {R}_{pt}} ] \} \times \frac{Φ sin α}{\sqrt{2 π} {σ}_{2}} exp [ - \frac{{( ( x - \frac{{L}_{G}}{2} ) + {R}_{p} sin α )}^{2}}{2 {σ}_{2}^{2}} ] + \{ \frac{1}{2} + \frac{1}{2} erf [ \frac{\begin{matrix}( x - \frac{{L}_{G}}{2} ) {σ}_{1}^{2} + {R}_{p} Δ {R}_{pt}^{2} sin α + \\ y ( Δ {R}_{p}^{2} - Δ {R}_{pt}^{2} ) sin α cos α\end{matrix}}{\sqrt{2} {σ}_{1} Δ {R}_{p} Δ {R}_{pt}} ] \} \times \frac{Φ cos α}{\sqrt{2 π} {σ}_{1}} exp [ - \frac{{( y - {R}_{p} cos α )}^{2}}{2 {σ}_{1}^{2}} ] \qquad ( 14 )$$

The border between the regions a₁ and a₂ is represented by the following formula (15).

$$y = ( x - \frac{{L}_{G}}{2} ) tan α \qquad ( 15 )$$

Herein, if approximation is performed as ΔRₚ≈ΔRₚₜ, the following simplified formula (16) is derived.

$${N}_{4 \_ R 90 \_ {a}_{2}} ( x , y ) = \{ \frac{1}{2} - \frac{1}{2} erf [ \frac{y - {R}_{p} cos α}{\sqrt{2} Δ {R}_{p}} ] \} \frac{Φ sin α}{\sqrt{2 π} Δ {R}_{p}} exp [ - \frac{{( ( x - \frac{{L}_{G}}{2} ) + {R}_{p} sin α )}^{2}}{2 Δ {R}_{p}^{2}} ] + \{ \frac{1}{2} + \frac{1}{2} erf [ \frac{( x - \frac{{L}_{G}}{2} ) + {R}_{p} sin α}{\sqrt{2} Δ {R}_{p}} ] \} \frac{Φ cos α}{\sqrt{2 π} Δ {R}_{p}} exp [ - \frac{{( y - {R}_{p} cos α )}^{2}}{2 Δ {R}_{p}^{2}} ] \qquad ( 16 )$$

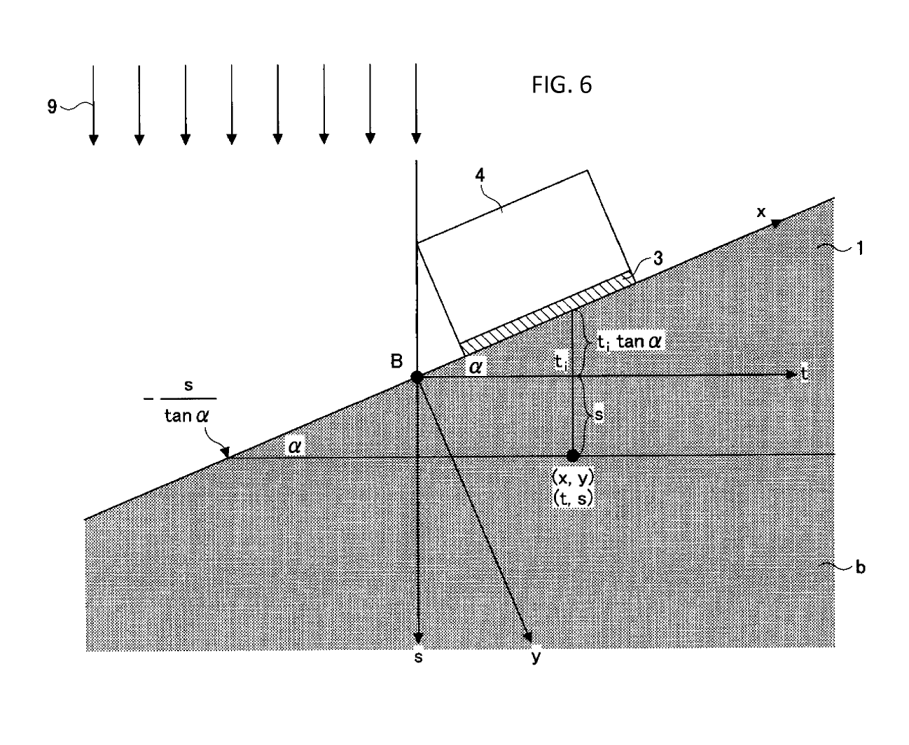

Subsequently, the region b subjected to the shadowing by the gate electrode 4 will be examined with reference to FIG. 6. Herein, the origin is set to a point B, and the gate electrode 4 is assumed to completely block the ion beams 9. In this case, the following formula (17) is derived by reference to FIG. 6.

$${N}_{4 \_ R 90 \_ b} ( t , s ) = Φ {\int }_{- s / tan α}^{0} \frac{1}{\sqrt{2 π} Δ {R}_{p}} exp [ - \frac{{( s - {t}_{i} tan α - {R}_{p} )}^{2}}{2 Δ {R}_{p}^{2}} ] \frac{1}{\sqrt{2 π} Δ {R}_{pt}} exp [ - \frac{{( t - {t}_{i} )}^{2}}{2 Δ {R}_{pt}^{2}} ] d {t}_{i} \qquad ( 17 )$$

Also in this case, the formula is subjected to integration and thereafter variable transformation. Thereby, the following formula (18) is derived.

$${N}_{4 \_ R 90 \_ b} ( x , y ) = \{ \frac{1}{2} erf [ \frac{\frac{y Δ {R}_{p}^{2}}{tan α} + {R}_{p} Δ {R}_{pt}^{2} sin α}{\sqrt{2} {σ}_{1} Δ {R}_{p} Δ {R}_{pt}} ] + \frac{1}{2} erf [ - \frac{x {σ}_{1}^{2} + {R}_{p} Δ {R}_{pt}^{2} sin α + y ( Δ {R}_{p}^{2} - Δ {R}_{pt}^{2} ) sin α cos α}{\sqrt{2} {σ}_{1} Δ {R}_{p} Δ {R}_{pt}} ] \} \times \frac{Φ cos α}{\sqrt{2 π} {σ}_{1}} exp [ - \frac{{( y - {R}_{p} cos α )}^{2}}{2 {σ}_{1}^{2}} ] \qquad ( 18 )$$

The distance between the origin B and the center of the gate is represented as d_{G}·tan α+L_{G}/2. If the origin B is shifted to the center of the gate, therefore, the following formula (19) is derived.

$${N}_{4 \_ R 90 \_ b} ( x , y ) = \{ \frac{1}{2} erf [ \frac{\frac{y Δ {R}_{p}^{2}}{tan α} + {R}_{p} Δ {R}_{pt}^{2} sin α}{\sqrt{2} {σ}_{1} Δ {R}_{p} Δ {R}_{pt}} ] + \frac{1}{2} erf [ - \frac{\begin{matrix}( x + {d}_{G} tan α + \frac{{L}_{G}}{2} ) {σ}_{1}^{2} + {R}_{p} Δ {R}_{pt}^{2} sin α + \\ y ( Δ {R}_{p}^{2} - Δ {R}_{pt}^{2} ) sin α cos α\end{matrix}}{\sqrt{2} {σ}_{1} Δ {R}_{p} Δ {R}_{pt}} ] \} \times \frac{Φ cos α}{\sqrt{2 π} {σ}_{1}} exp [ - \frac{{( y - {R}_{p} cos α )}^{2}}{2 {σ}_{1}^{2}} ] \qquad ( 19 )$$

### First Embodiment

With the use of the above-described formulae, a method for further simplification will be described below. The two-dimensional model based on the formulae presented in “Assumption” described above will be referred to as the “analysis model,” and a simplified two-dimensional model obtained by simplification of the “analysis model” will be referred to as the “simplified analysis model.”

In “Assumption,” Rₚ, ΔRₚ, and ΔRₚₜ represent the range projection, the straggling of the range projection in the longitudinal direction, and the straggling of the range projection in the transverse direction, respectively. On the basis of the above-described formulae (6) and (11), therefore, a collision cross section σ₁ in the longitudinal direction and a collision cross section σ₂ in the transverse direction obtained by the interaction between the implanted ions and the nuclei of the substrate 1 may be respectively represented as follows.

σ₁=\sqrt{ΔRₚ² cos² α+ΔRₚₜ² sin² α} (20)

σ₁=\sqrt{ΔRₚ² sin² α+ΔRₚₜ² cos² α} (21)

The above formulae are subjected to approximation to be simplified.

The approximation is first performed as ΔRₚ≈ΔRₚₜ, and the following equation is set.

ΔRₚ=ΔRₚₜ=σ₁=σ₂≡σ (22)

Accordingly, the formula (14) is represented as follows.

$${N}_{4 \_ R 90 \_ {a}_{2}} ( x , y ) = \{ \frac{1}{2} - \frac{1}{2} erf [ \frac{y - {R}_{p} cos α}{\sqrt{2} σ} ] \} \times \frac{Φ sin α}{\sqrt{2 π} σ} exp [ - \frac{{( ( x - \frac{{L}_{G}}{2} ) + {R}_{p} sin α )}^{2}}{2 {σ}^{2}} ] + \{ \frac{1}{2} + \frac{1}{2} erf [ \frac{( x - \frac{{L}_{G}}{2} ) + {R}_{p} sin α}{\sqrt{2} σ} ] \} \times \frac{Φ cos α}{\sqrt{2 π} σ} exp [ - \frac{{( y - {R}_{p} cos α )}^{2}}{2 {σ}^{2}} ] \qquad ( 23 )$$

If x is a large value, therefore, the following equation holds.

$${N}_{4 \_ R 90 \_ {a}_{2}} ( x , y ) = \frac{Φcos α}{\sqrt{2 π} σ} exp [ - \frac{{( y - {R}_{p} cos α )}^{2}}{2 {σ}^{2}} ] \qquad ( 24 )$$

The formula (24) is compared with the formula (8) for the region a₁. The coefficient in front of the formula (8) indicates that the surface side has no contribution to the concentration.

When the depth from the surface reaches or exceeds √2σ tan α, approximation is performed as follows.

$${N}_{4 \_ R 90 \_ {a}_{1}} ( x , y ) = \frac{Φcos α}{\sqrt{2 π} {σ}_{1}} exp [ - \frac{{( y - {R}_{p} cos α )}^{2}}{2 {σ}_{1}^{2}} ] \qquad ( 25 )$$

If the collision cross section σ in the formula (24) is replaced by σ₁, the formulae match each other. In view of this, the following equation is proposed which uses σ₁ and σ₂ as the collision cross section σ in the longitudinal direction and the collision cross section σ in the transverse direction, respectively, in the formula (23).

$${N}_{4 \_ R 90 \_ a} ( x , y ) = \{ \frac{1}{2} - \frac{1}{2} erf [ \frac{y - {R}_{p} cos α}{\sqrt{2} {σ}_{1}} ] \} \times \frac{Φ sin α}{\sqrt{2 π} {σ}_{2}} exp [ - \frac{{( ( x - \frac{{L}_{G}}{2} ) + {R}_{p} sin α )}^{2}}{2 {σ}_{2}^{2}} ] + \{ \frac{1}{2} + \frac{1}{2} erf [ \frac{( x - \frac{{L}_{G}}{2} ) + {R}_{p} sin α}{\sqrt{2} {σ}_{2}} ] \} \times \frac{Φ cos α}{\sqrt{2 π} {σ}_{1}} exp [ - \frac{{( y - {R}_{p} cos α )}^{2}}{\sqrt{2} {σ}_{1}^{2}} ] \qquad ( 26 )$$

This configuration is expected to provide an effect of compensating for the degradation of accuracy caused by the rough approximation ΔRₚ≈ΔRₚₜ used so far. The formula (26) matches the approximate formula (25) for the region a₁ in the limit of a large x value. That is, the formula (26) is used as an effective approximate formula for the regions a₁ and a₂.

The approximation of the formula (24) is also used for the region b, and the following equation is derived.

$${N}_{4 \_ R 90 \_ b} ( x , y ) = \{ \frac{1}{2} erf [ \frac{\frac{y}{tan α} + {R}_{p} sin α}{\sqrt{2} σ} ] + \frac{1}{2} erf [ - \frac{( x + {d}_{G} tan α + \frac{{L}_{G}}{2} ) + {R}_{p} sin α}{\sqrt{2} σ} ] \} \times \frac{Φ cos α}{\sqrt{2 π} σ} exp [ - \frac{{( y - {R}_{p} cos α )}^{2}}{2 {σ}^{2}} ] \qquad ( 27 )$$

Also in this case, when the depth reaches or exceeds √2σ tan α, simplification is performed as follows.

$${N}_{4 \_ R 90 \_ b} ( x , y ) = \{ \frac{1}{2} + \frac{1}{2} erf [ - \frac{( x + {d}_{G} tan α + \frac{{L}_{G}}{2} ) + {R}_{p} sin α}{\sqrt{2} σ} ] \} \times \frac{Φ cos α}{\sqrt{2 π} σ} exp [ - \frac{{( y - {R}_{p} cos α )}^{2}}{2 {σ}^{2}} ] \qquad ( 28 )$$

Also in the formula (28), the collision cross section σ in the longitudinal direction and the collision cross section σ in the transverse direction are replaced by σ₁ and σ₂, respectively. Thereby, the following equation is derived.

$${N}_{4 \_ R 90 \_ b} ( x , y ) = \{ \frac{1}{2} + \frac{1}{2} erf [ - \frac{( x + {d}_{G} tan α + \frac{{L}_{G}}{2} ) + {R}_{p} sin α}{\sqrt{2} σ} ] \} \times \frac{Φ cos α}{\sqrt{2 π} {σ}_{1}} exp [ - \frac{{( y - {R}_{p} cos α )}^{2}}{2 {σ}_{1}^{2}} ] \qquad ( 29 )$$

The pocket ion implantation concentration distribution N₄_{_{—}}_{R270} for the rotation angle of 270° is considered to be symmetrical with the distribution N₄_{_{—}}_{R90} with respect to the center of the gate. Therefore, the pocket ion implantation concentration distribution N₄_{_{—}}_{R270} is represented as follows.

N₄_{_{—}}_{R270}(x,y)=N₄_{_{—}}_{R290}(−x,y) (30)

The distribution obtained by the third ion implantation with the rotation angle of 0° and the distribution obtained by the fourth ion implantation with the rotation angle of 180° are both represented as follows.

$${N}_{4 \_ R 0 , 180} ( x , y ) = [ 1 - \frac{erf ( \frac{\frac{{L}_{G}}{2} - x}{\sqrt{2} Δ {R}_{pt}} ) + erf ( \frac{\frac{{L}_{G}}{2} + x}{\sqrt{2} Δ {R}_{pt}} )}{2} ] \frac{Φ}{\sqrt{2 π} {σ}_{1}} exp [ - \frac{{( y - {R}_{p} cos α )}^{2}}{2 {σ}_{1}^{2}} ] \qquad ( 31 )$$

The pocket ion implantation distribution is represented by the following equation which sums the above values.

$${N}_{4} = {\sum }_{R} {N}_{4 \_ R} \qquad ( 32 )$$

Therefore, the sum of the respective values of the above-described formulae (1), (2), (3), (4), and (32) corresponds to the total impurity concentration distribution in the entire ion implantation process.

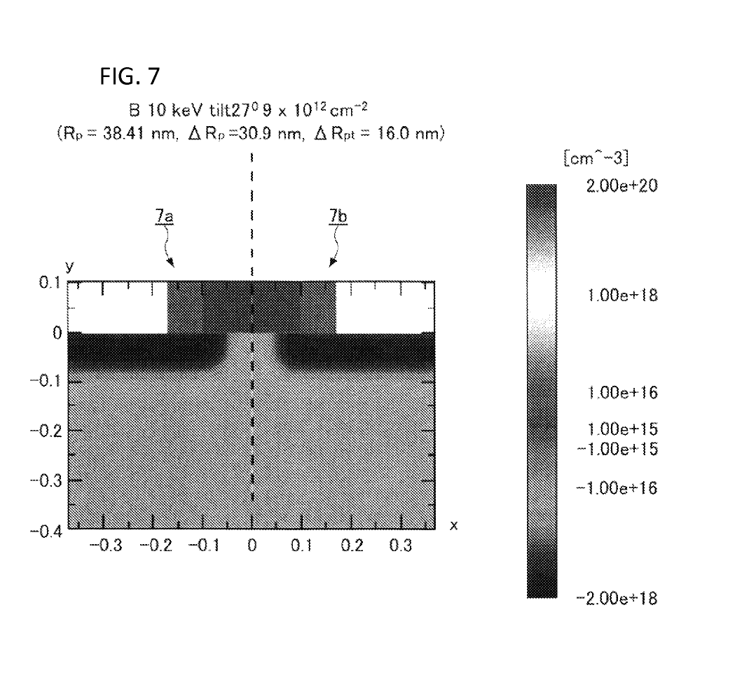

FIG. 7 is a diagram illustrating comparison of analysis models of the two-dimensional concentration distribution. In the two-dimensional concentration distributions illustrated in FIG. 7, a simplified analysis model 7a, which does not requeste the separation between the regions a₁ and a₂, is represented by the pocket ion implantation distribution in the regions a and b, and an analysis model 7b prior to the simplification is represented by the pocket ion implantation distribution in the regions a₁, a₂, and b prior to the derivation as the simplified analysis model 7a.

The drawing further illustrates two-dimensional ion implantation distributions in a MOS-structure substrate having a gate length of 0.2 μm subjected to the pocket ion implantation, wherein the doping has been performed under an ion implantation condition of ions of B, acceleration energy of 10 keV, a dose of 9×10¹² cm⁻², and a tilt angle of 27°. In this case, Rₚ, ΔRₚ, and ΔRₚₜ are 38.41 nm, 30.9 nm, and 16.0 nm, respectively, and it is understood that the simplified analysis model 7a and the analysis model 7b substantially match each other.

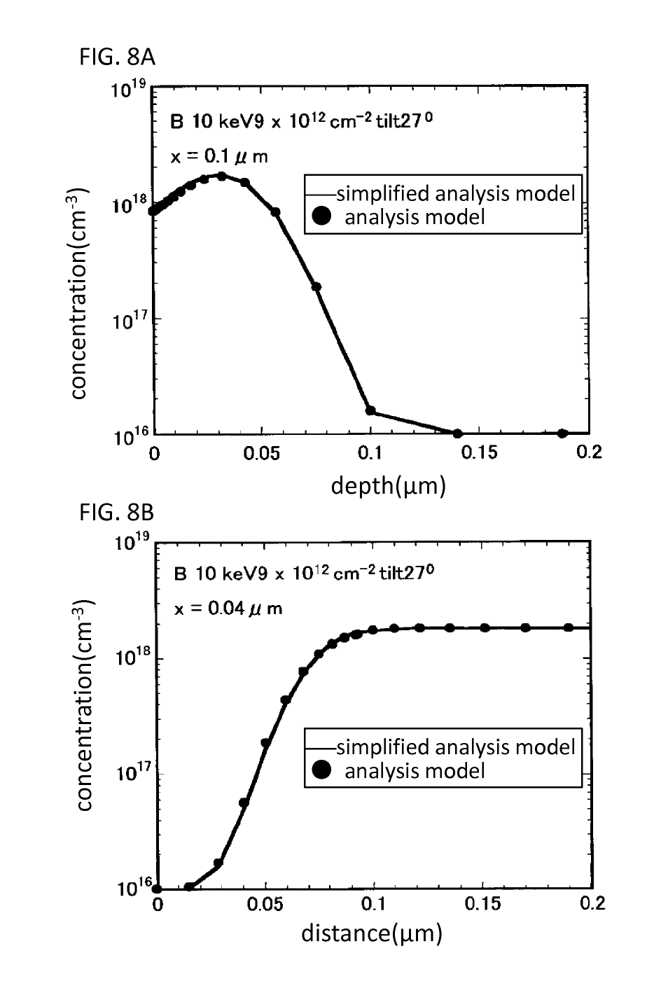

FIGS. 8A and 8B are diagrams illustrating compassions, in a longitudinal distribution and a transverse distribution, of the two-dimensional ion implantation distributions illustrated in FIG. 7.

In FIG. 8A, which is a line chart with the vertical axis representing the concentration of the implanted ions and the horizontal axis representing the depth from the surface of the substrate 1, a solid line represents the shape of the ion distribution obtained by the simplified analysis model 7a, and distribution points represent the shape of the ion distribution obtained by the analysis model 7b. The drawing thereby illustrates a longitudinal distribution of each of the two-dimensional ion implantation distributions at an end of the gate.

In FIG. 8B, which is a line chart with the vertical axis representing the concentration of the implanted ions and the horizontal axis representing the distance of the straggling in the transverse direction in the vicinity of a position having a depth corresponding to the peak concentration of the ion distributions in FIG. 8A, a solid line represents the shape of the ion distribution obtained by the simplified analysis model 7a, and distribution points represent the shape of the ion distribution obtained by the analysis model 7b.

The simplified analysis model 7a and the analysis model 7b match each other well both in the two-dimensional impurity concentration distribution in the longitudinal direction at an end of the gate, which is illustrated in FIG. 8A, and the two-dimensional impurity concentration distribution in the transverse direction in the vicinity of a position having a depth corresponding to the peak concentration, which is illustrated in FIG. 8B.

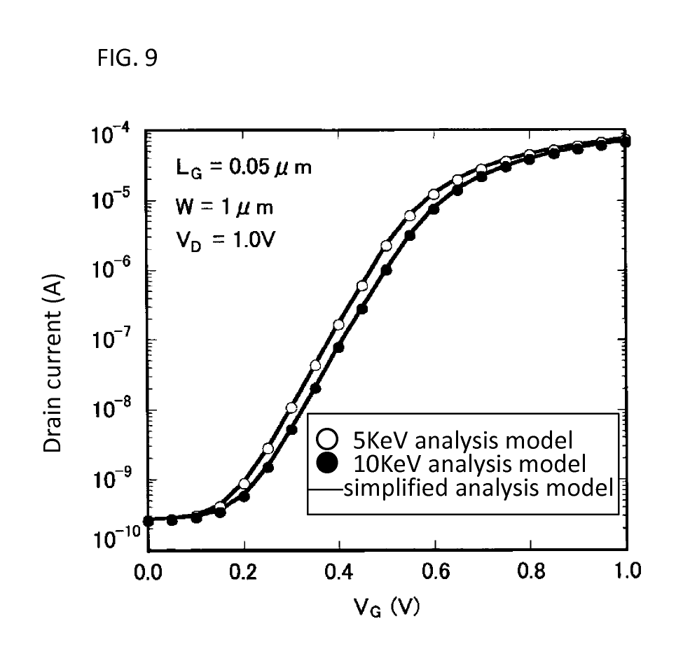

FIG. 9 illustrates current characteristics obtained by evaluation based on the respective two-dimensional impurity concentration distributions of the simplified analysis model 7a and the analysis model 7b input in a two-dimensional device simulator (see Hisamoto D. et al. and Ryu S.-W. et al. included in the above-mentioned related art). FIG. 9 is a diagram illustrating comparison of the simplified analysis model 7a and the analysis model 7b in terms of a current characteristic. In FIG. 9, the simplified analysis model 7a well reproduces the analysis model 7b under both conditions of acceleration energy of 5 keV and acceleration energy of 10 keV for a configuration having a gate length L_{G} of 0.05 μm, a device width W of 1 μm, and a drain voltage V_{D} of 1.0 V.

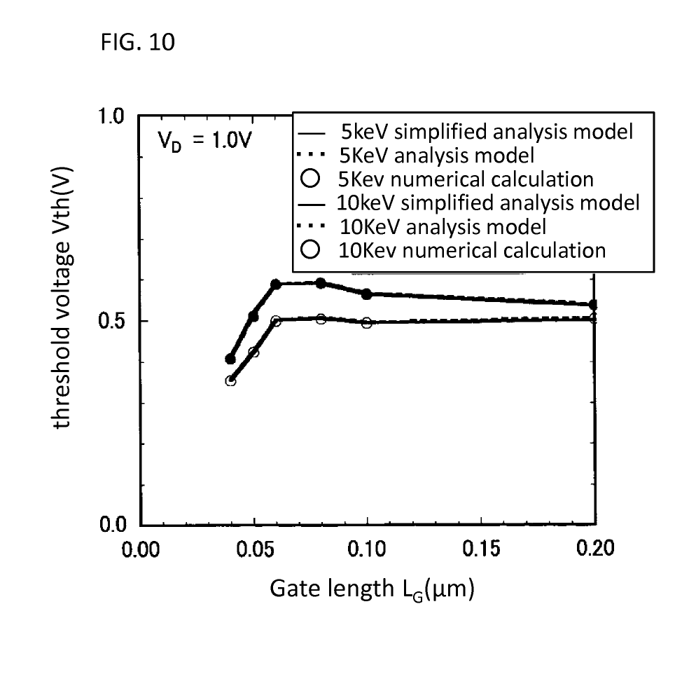

FIG. 10 illustrates the gate length dependence of a threshold voltage Vₜₕ. FIG. 10 is a diagram illustrating comparison of the simplified analysis model 7a and the analysis model 7b in terms of the gate length dependence of the threshold voltage Vₜₕ. FIG. 10 also illustrates, for reference purposes, the result of numerical calculation performed on the basis of the distribution obtained by two-dimensional process simulation. The threshold voltage Vₜₕ is defined as the gate voltage, at which a drain current I_{D} obtained by numerical calculation and standardized by a device size of the gate length L_{G} and the device width W is represented as follows.

$$\frac{{L}_{G}}{W} {I}_{D} = 5 \times {10}^{- 7} A \qquad ( 33 )$$

The simplified analysis model 7a well reproduces the analysis model 7b and the result of the numerical calculation.

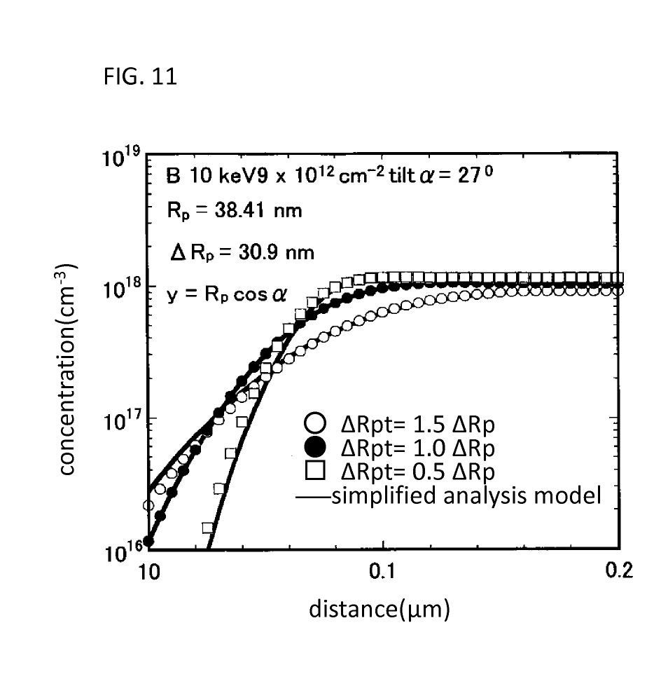

To verify, under wider conditions, the accuracy of the simplified analysis model 7a in this case, the result of examination to find whether or not an equation ΔRₚₜ=rΔRₚ is consistent with the distributions is illustrated in FIG. 11. FIG. 11 is a diagram illustrating comparison of transverse distributions obtained with various ΔRₚₜ values. By the nature of approximation, the accuracy is the highest with an r value of 1. In both cases in which the r value deviates from 1, the analysis models match each other substantially well, although there is a slight difference between the cases. In FIGS. 8A, 8B, 9, and 10, the r value substantially corresponds to 0.5. In the range of the r value from 0.5 to 1.5, therefore, the analysis models match each other in the electrical characteristic at the level of FIG. 10. In the case of actual ions, the r value substantially falls in this range. It is therefore considered that there is no problem in practical use.

### Second Embodiment

In a second embodiment, description will be made of a method of geometrically interpreting the simplified analysis model to apply the simplified analysis model to a generalized analysis model independent of the MOS structure, and allowing the simplified analysis model to be expanded into a three-dimensional model.

With the use of the following formula (34) in the simplified formula (26) for the region a, coordinate transformation into the Rₚ line is performed.

$$\{ \begin{matrix}{u}_{a} = x - ( \frac{{L}_{G}}{2} - {R}_{p} sin α ) \\ {v}_{a} = y - {R}_{p} cos α\end{matrix} \qquad ( 34 )$$

Thereby, the following equation is derived which is represented in a simpler form.

$${N}_{4 \_ R 90 \_ a} ( {u}_{a} , {v}_{a} ) = \{ \frac{1}{2} - \frac{1}{2} erf [ \frac{{v}_{a}}{\sqrt{2} {σ}_{1}} ] \} \times \frac{Φ sin α}{\sqrt{2 π} {σ}_{2}} exp [ - \frac{{u}_{a}^{2}}{2 {σ}_{2}^{2}} ] + \{ \frac{1}{2} + \frac{1}{2} erf [ \frac{{u}_{a}}{\sqrt{2} {σ}_{2}} ] \} \times \frac{Φ cos α}{\sqrt{2 π} {σ}_{1}} exp [ - \frac{{v}_{a}^{2}}{2 {σ}_{1}^{2}} ] \qquad ( 35 )$$

The coordinate transformation into the Rₚ line corresponds to the transformation into rectilinear coordinates representing the range projection Rₚ (peak concentration position). The straight line represented by the transformed coordinates will be referred to as the “Rₚ line” in the present embodiment.

In a similar manner, coordinate transformation into the Rₚ line is performed by the use of the following formula (36) in the simplified formula (29) for the region b.

$$\{ \begin{matrix}{u}_{b} = x + ( \frac{{L}_{G}}{2} + {d}_{G} sin α + {R}_{p} sin α ) \\ {v}_{b} = y - {R}_{p} cos α\end{matrix} \qquad ( 36 )$$

Thereby, the following equation is derived.

$${N}_{4 \_ R 90 \_ b} ( {u}_{b} , {v}_{b} ) = \{ \frac{1}{2} + \frac{1}{2} erf [ - \frac{{u}_{b}}{\sqrt{2} {σ}_{2}} ] \} \times \frac{Φ cos α}{\sqrt{2 π} {σ}_{1}} exp [ - \frac{{v}_{b}^{2}}{2 {σ}_{1}^{2}} ] \qquad ( 37 )$$

With the formulae (35) and (37), the two-dimensional distribution in a patterned substrate of any shape may be easily geometrically interpreted and generated as follows. In the ion implantation into a given pattern, straight lines each representing the range projection Rₚ are first drawn. The respective straight lines may correspond one-to-one to the surfaces subjected to the ion implantation.

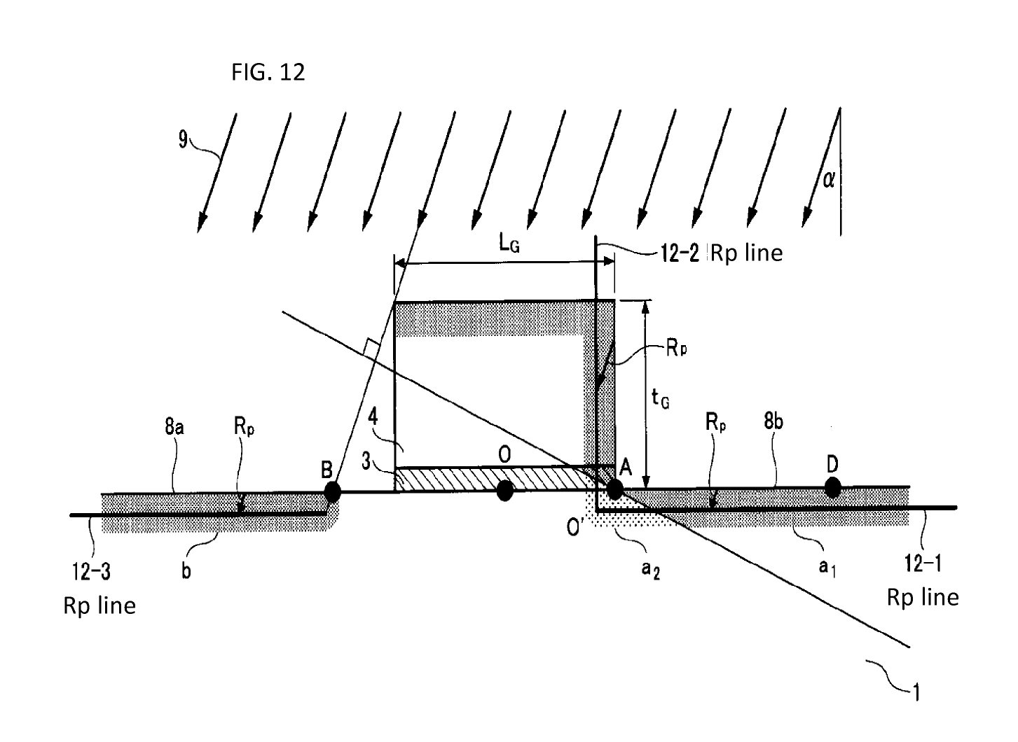

FIG. 12 is a diagram illustrating semi-infinite Rₚ lines. In FIG. 12, when the ion implantation is performed on the substrate 1 from the right side at a tilt angle θ, an Rₚ line 12-1 is a half line formed on the basis of the range projection Rₚ in a surface of a drain region 8b, and an Rₚ line 12-2 is a half line formed on the basis of the range projection Rₚ in a surface of the gate electrode 4 on the side of the drain region 8b. Further, an Rₚ line 12-3 is a half line formed on the basis of the range projection Rₚ in a surface of a source region 8a.

The two-dimensional impurity concentration distribution related to one Rₚ line is represented in the following form in any case.

$$N ( u , v ) = \frac{1}{2} erfc ( \frac{u}{\sqrt{2} {σ}_{u}} ) \times \frac{Φ cos θ}{\sqrt{2 π} {σ}_{v}} exp [ - \frac{{v}^{2}}{2 {σ}_{v}^{2}} ] \qquad ( 38 )$$

Herein, v and u respectively represent a unit vector in a vertical direction and a unit vector in a horizontal direction with respect to a plane, and the direction from an implanted region to an unimplanted region corresponds to the positive direction. Further, θ represents an angle relative to the vertical direction with respect to the plane.

As illustrated in FIG. 12, the formula (38) assumes a semi-infinite straight line. In this case, the other end of the line, which is approximated to infinity, has a small contribution, and thus poses little problem. In general, however, it is requested to take into account of a line segment having a length L and endpoints on both sides of the straight line in the horizontal direction u. If the midpoint of each line segment is set to the origin of the line segment, the formula is expanded as in the following formula (39), also in the case assuming the half line.

$$N ( u , v ) = \frac{erf ( \frac{\frac{L}{2} - u}{\sqrt{2} {σ}_{u}} ) + erf ( \frac{\frac{L}{2} + u}{\sqrt{2} {σ}_{u}} )}{2} \times \frac{Φ cos θ}{\sqrt{2 π} {σ}_{v}} exp [ - \frac{{v}^{2}}{2 {σ}_{v}^{2}} ] \qquad ( 39 )$$

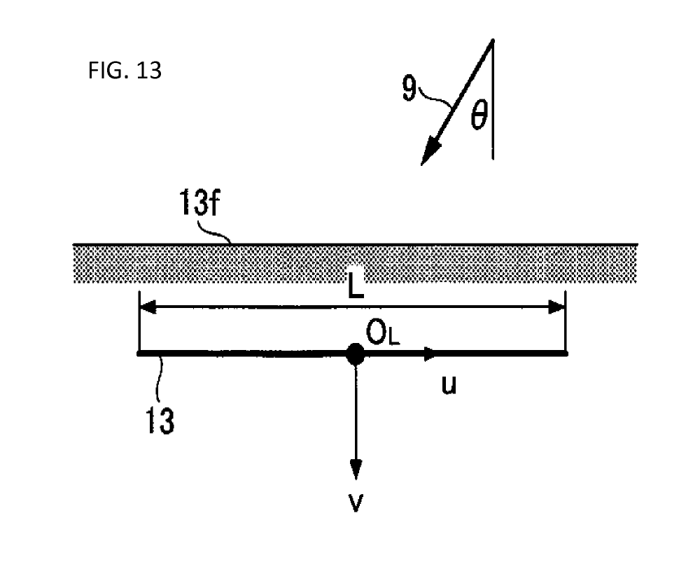

Accordingly, the two-dimensional impurity concentration distribution is defined is a generalized Rₚ line as illustrated in FIG. 13 described later. A function expressing this transverse distribution is represented as follows.

$${f}_{u} ( u , {L}_{u} , {σ}_{u} ) = \frac{erf ( \frac{\frac{{L}_{u}}{2} - u}{\sqrt{2} {σ}_{u}} ) + erf ( \frac{\frac{{L}_{u}}{2} + u}{\sqrt{2} {σ}_{u}} )}{2} \qquad ( 40 )$$

If the semi-infinite straight line is easier to handle in the analysis, the formula (38) is used as reqeted.

FIG. 13 is a diagram illustrating the definition of the Rₚ line. As illustrated in FIG. 13, when the ion implantation is performed on a surface 13f from the right side at the tilt angle θ, the origin O_{L} is set to the midpoint of an Rₚ line 13 having a length L and endpoints on both sides of the straight line in the horizontal direction u. It is thereby possible to define the generalized Rₚ line.

Subsequently, description will be made of the expansion into the three-dimensional model with reference to examples of the rotation angles of 0°, 90°, 180°, and 270°. In the ion implantation into the surface 13f in FIG. 13, there are two horizontal directions in the three-dimensional space. Therefore, another horizontal direction s is introduced in the formula (35). The horizontal direction s corresponds to a horizontal axis relative to the vertical direction with respect to the surface subjected to the ion implantation at the tilt angle θ. That is, the value σ in the direction constantly represents the straggling ΔRₚₜ of the range projection in the transverse direction.

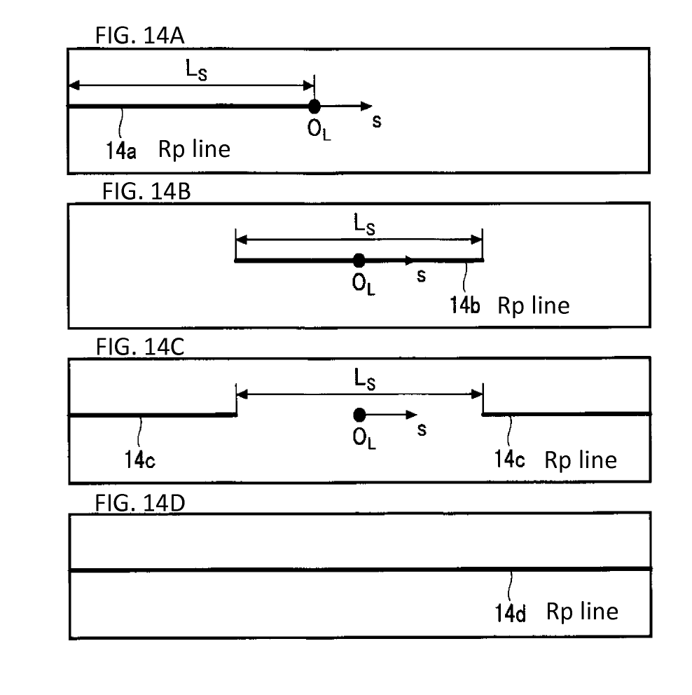

FIGS. 14A to 14D are diagrams for explaining the types of the Rₚ line in the horizontal direction s. FIG. 14A illustrates a pattern a, in which a length Lₛ represents the length of an Rₚ line 14a that has one endpoint corresponding to the origin O_{L}. FIG. 14B illustrates a pattern b, in which the length Lₛ represents the length of an Rₚ line 14b that includes the origin O_{L}. FIG. 14C illustrates a pattern c, in which the length Lₛ represents the length of a space in an Rₚ line 14c that does not include the origin O_{L}. FIG. 14D illustrates a pattern d, in which an Rₚ line 14d extends over the entire region, and which is two-dimensional in a direction other than the horizontal direction s. The patterns a to d are based on the presence or absence of contribution of the ion implantation.

When the Rₚ lines 14a, 14b, 14c, and 14d are represented as a gₛ_{_{—}}ₐ, gₛ_{_{—}}_{b}, gₛ_{_{—}}_{c}, and gₛ_{_{—}}_{d}, respectively, the Rₚ lines 14a, 14b, 14c, and 14d are expressed as follows.

$${g}_{s} ( s , {L}_{s} , {σ}_{s} ) = \{ \begin{matrix}{g}_{s \_ a} ( s , {L}_{s} , {σ}_{s} ) = \frac{1}{2} erf ( \frac{s}{\sqrt{2} {σ}_{s}} ) \\ {g}_{s \_ b} ( s , {L}_{s} , {σ}_{s} ) = \frac{erf ( \frac{\frac{{L}_{s}}{2} - s}{\sqrt{2} {σ}_{s}} ) + erf ( \frac{\frac{{L}_{s}}{2} + s}{\sqrt{2} {σ}_{s}} )}{2} \\ {g}_{s \_ c} ( s , {L}_{s} , {σ}_{s} ) = 1 - \frac{erf ( \frac{\frac{{L}_{s}}{2} - s}{\sqrt{2} {σ}_{s}} ) + erf ( \frac{\frac{{L}_{s}}{2} + s}{\sqrt{2} {σ}_{s}} )}{2} \\ {g}_{s \_ d} ( s , {σ}_{s} ) = 1\end{matrix} \qquad ( 41 )$$

The three-dimensional impurity concentration distribution in this case is represented as follows.

$$N ( s , u , v ) = {g}_{s} ( s , {L}_{s} , {σ}_{s} ) {f}_{u} ( u , {L}_{u} , {σ}_{u} ) \times \frac{Φ cos θ}{\sqrt{2 π} {σ}_{v}} exp [ - \frac{{v}^{2}}{2 {σ}_{v}^{2}} ] \qquad ( 42 )$$

The above three-dimensional model is limited to the rotation angles of 0°, 90°, 180°, and 270°.

Further, a general polygon may be drawn on the xy-plane. The tilt angle may be set to an arbitrary value, but limited in the plane and not in the z-direction, i.e., the tilt angle of an arbitrary value may be set in a quasi-three-dimensional structure.

In the case of a rectangular shape, the application in the z-direction is also possible, as illustrated in an application example described below.

### Application Example to Three-Dimensional Structure

Description will be made of an example in which the above-described three-dimensional analysis model is applied to FinFET (see Hisamoto D. et al. and Ryu S.-W. et al. included in the above-mentioned related art), which has attracted attention as an advanced device.

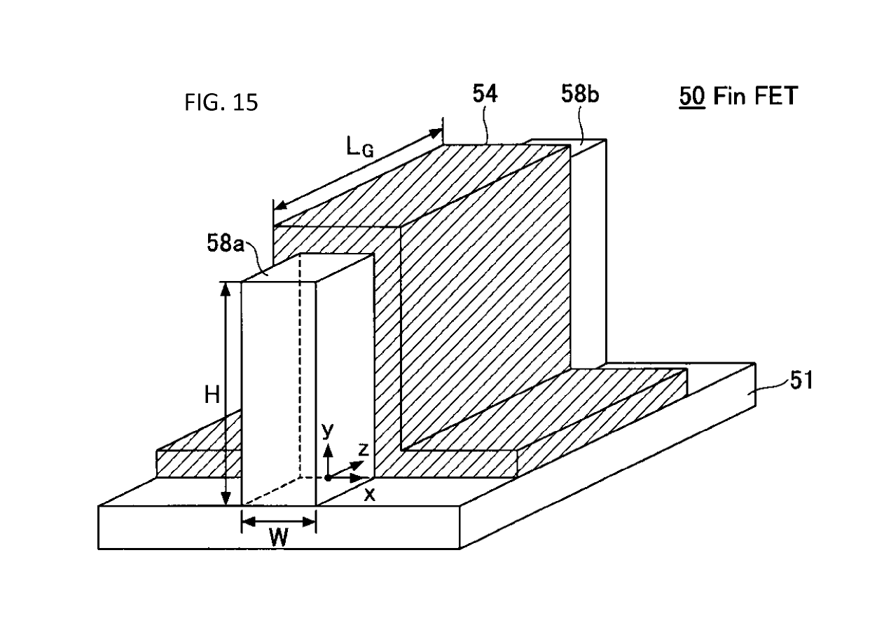

FIG. 15 is a bird's-eye view of a FinFET. A FinFET 50 as illustrated in FIG. 15 is now assumed which includes a substrate 51 formed with a source region 58a and a drain region 58b each having a height H and a width W and a gate electrode 54 having a gate length L_{G}. The origin of the coordinates (x, y, z) is set to the center of a lower portion of the fin, and the z-direction is set along the center of the gate. In FIG. 15, the origin of the coordinate z is set at an end of the source for visual clarification, and thus only the direction thereof is illustrated.

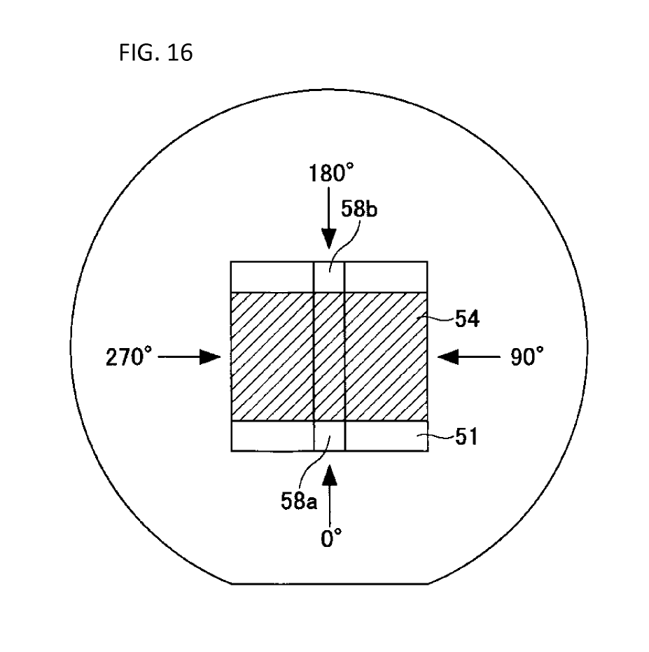

FIG. 16 is a diagram for explaining the definition of rotation angles for ion implantation into a FinFET. In FIG. 16, if the rotation angle of 0° is assumed to be the angle for ion implantation into the source region 58a, for example, the rotation angle of 90° is the angle for ion implantation into the source region 58a and the drain region 58b performed after a 90° rotation to the left from the rotation angle of 0°. Further, the rotation angle of 180° is the angle for ion implantation into the drain region 58b performed after another 90° rotation to the left, and the rotation angle of 270° is the angle for ion implantation into the source region 58a and the drain region 58b performed after still another 90° rotation to the left.

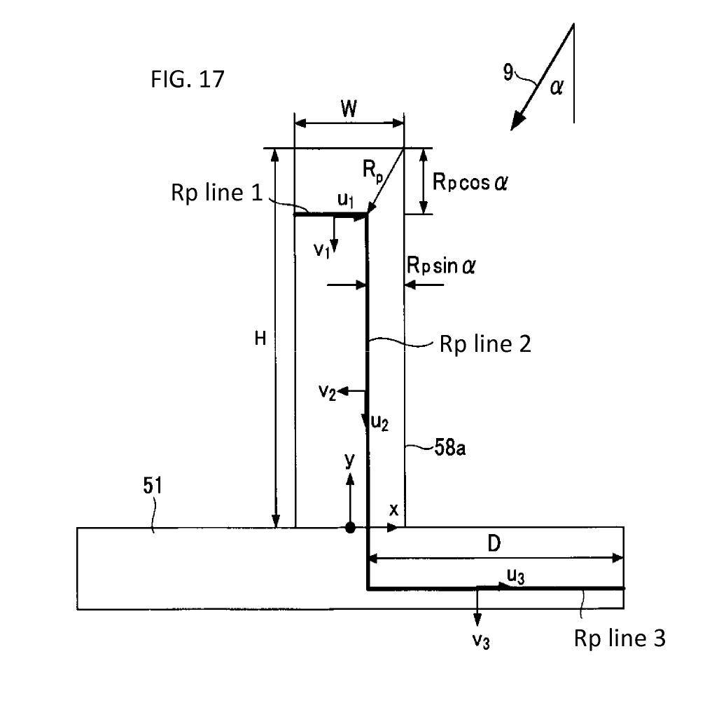

An example is now assumed wherein the ion implantation is performed at the tile angle α with the rotation angles of 90° and 270° to dope the source region 58a and the drain region 58b. The impurity concentration distribution N_{R90} for the rotation angle of 90° will be first discussed. FIG. 17 is a diagram illustrating an example of Rₚ lines for the rotation angle of 90°. In FIG. 17, description will be made of an example in which the Rₚ lines are drawn in the source region 58a.

An Rₚ line 1 represents a straight line drawn in the source region 58a on the basis of the range projection Rₚ from the upper surface of the region, and an Rₚ line 2 represents a straight line drawn in the source region 58a on the basis of the range projection Rₚ from a side surface of the region subjected to the ion implantation. Further, an Rₚ line 3 represents a straight line drawn in the substrate 51 on the basis of the range projection Rₚ from a surface of the substrate subjected to the ion implantation. A distance D represents the length from the right side surface of the substrate 51 subjected to the ion implantation to the Rₚ line 2.

The origin is set at the center of each of the Rₚ lines 1, 2, and 3, and the formula (37) is applied with coordinates (u1, v1), (u2, v2), and (u3, v3) each representing the vertical and horizontal directions with respect to the corresponding surface. The Rₚ lines represented as gₛ all correspond to the pattern c illustrated in FIG. 14C. The length Lₛ of the space in the Rₚ line 14c illustrated in FIG. 14C corresponds to the gate length L_{G} of the FinFET 50 illustrated in FIG. 15.

With the application of the formula (37), the two-dimensional impurity concentration distribution related to the Rₚ line 1 is represented as follows.

N_{R90}_{_{—}}₁(s,u₁,v₁)=gₛ_{_{—}}_{c}(s,L_{G},σₛ)fᵤ(u₁,W−Rₚ sin α,σᵤ)fᵥ(v₁) (43)

The variable transformation is represented as follows.

$$\{ \begin{matrix}θ = α \\ x = {u}_{1} - \frac{{R}_{p} sin α}{2} \\ y = - [ {v}_{1} - ( H - {R}_{p} cos α ) ] \\ z = s\end{matrix} \qquad ( 44 )$$

With the application of the formula (37), the two-dimensional impurity concentration distribution related to the Rₚ line 2 is represented as follows.

N_{R90}_{_{—}}₂(s,u₂,v₂)=gₛ_{_{—}}_{c}(s,L_{G},σₛ)fᵤ(u₂,H,σᵤ)fᵥ(v₂) (45)

The variable transformation in this case is represented as follows.

$$\{ \begin{matrix}θ = \frac{π}{2} - α \\ x = - [ {v}_{2} - ( \frac{W}{2} - {R}_{p} sin α ) ] \\ y = - [ {u}_{2} - ( \frac{H}{2} - {R}_{p} cos α ) ] \\ z = s\end{matrix} \qquad ( 46 )$$

The two-dimensional impurity concentration distribution related to the Rₚ line 3 does not contribute to the channel region, but will be described herein for the sake of generality.

N_{R90}_{_{—}}₃(s,u₃,v₃)=gₛ_{_{—}}_{c}(s,L_{G},σₛ)fᵤ(u₃,W,σᵤ)fᵥ(v₃) (47)

The variable transformation in this case is represented as follows.

$$\{ \begin{matrix}θ = α \\ x = {u}_{3} + ( \frac{W}{2} - {R}_{p} sin α + \frac{D}{2} ) \\ y = - [ {v}_{3} + {R}_{p} cos α ] \\ z = s\end{matrix} \qquad ( 48 )$$

In any case, the following equations hold.

$$\{ \begin{matrix}{σ}_{v} = \sqrt{Δ {R}_{p}^{2} {cos}^{2} θ + Δ {R}_{pt}^{2} {sin}^{2} θ} \\ {σ}_{u} = \sqrt{Δ {R}_{pt}^{2} {cos}^{2} θ + Δ {R}_{p}^{2} {sin}^{2} θ} \\ {σ}_{s} = Δ {R}_{pt}\end{matrix} \qquad ( 49 )$$

Therefore, the two-dimensional impurity concentration distribution N_{R90} for the rotation angle of 90° is obtained by the sum of the two-dimensional impurity concentration distributions N_{R0}_{_{—}}₁ to N_{R0}_{_{—}}₃ for the Rₚ lines 1 to 3, and thus are handled as the following equation.

N_{R90}=N_{R90}_{_{—}}₁+N_{R90}_{_{—}}₂+N_{R90}_{_{—}}₃ (50)

The two-dimensional impurity concentration distribution for the rotation angle of 270° is symmetrical with the above-described distribution with respect to the yz-plane with an x value of 0, and thus is represented as follows.

N_{R}_{_{—}}₂₇₀(x,y,z)=N_{R}_{_{—}}₉₀(−x,y,z) (51)

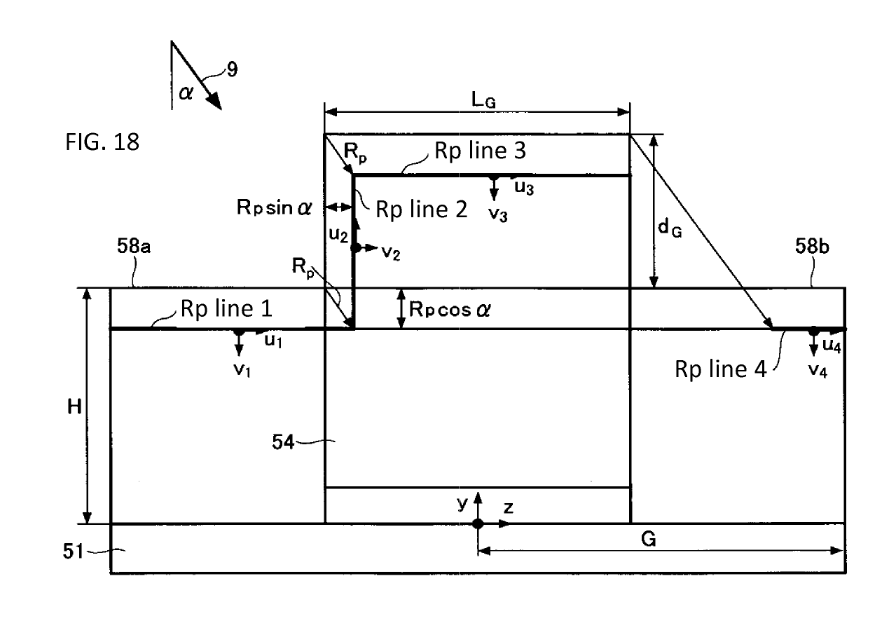

Subsequently, an example of the rotation angle of 0° will be discussed. Description of specific calculations will be omitted. In this case, the Rₚ lines as illustrated in FIG. 18 are drawn. FIG. 18 is a diagram illustrating an example of Rₚ lines for the rotation angle of 0°. FIG. 18 illustrates an example of Rₚ lines for ion implantation performed at the tilt angle α from the side of the source region 58a.

An Rₚ line 1 represents a straight line drawn in the source region 58a on the basis of the range projection Rₚ from the upper surface of the region. Further, an Rₚ line 2 represents a straight line drawn in the gate electrode 54 on the basis of the range projection Rₚ from a side surface of the electrode subjected to the ion implantation, and an Rₚ line 3 represents a straight line drawn in the gate electrode 54 on the basis of the range projection Rₚ from the upper surface of the electrode. Further, an Rₚ line 4 represents a straight line drawn in the drain region 58b on the basis of the range projection Rₚ from a portion of the upper surface of the region subjected to the ion implantation (a portion not blocked by the gate electrode 54).

A height d_{G} represents the height from the upper surface of the drain region 58b to the upper surface of the gate electrode 54, and a distance G represents the distance from the center of the gate electrode 54 to a side surface of the substrate 51.

The origin is set at the center of each of the Rₚ lines 1, 2, 3, and 4, and the formula (37) is applied with coordinates (u1, v1), (u2, v2), (u3, v3), and (u4, v4) each representing the vertical and horizontal directions with respect to the corresponding surface. As for the horizontal direction s in this case, the definition of the Rₚ line is directly used. The Rₚ line having the width W in the horizontal direction s (x-direction) corresponds to the Rₚ line 14b of FIG. 14B having the length Lₛ, and thus corresponds to the pattern b.

With the application of the formula (37), the two-dimensional impurity concentration distribution related to the Rₚ line 1 is represented as follows.

$${N}_{R 0 \_ 1} ( s , {u}_{1} , {v}_{1} ) = {g}_{s \_ b} ( s , W , {σ}_{s} ) {f}_{u} ( {u}_{1} , G - \frac{{L}_{G}}{2} {R}_{p} sin α , {σ}_{u} ) {f}_{v} ( {v}_{1} ) \qquad ( 52 )$$

The variable transformation in this case is represented as follows.

$$\{ \begin{matrix}θ = α \\ x = s \\ y = - [ {v}_{1} - ( H - {R}_{p} cos α ) ] \\ z = {u}_{1} + \frac{G + \frac{{L}_{G}}{2} - {R}_{p} sin α}{2}\end{matrix} \qquad ( 53 )$$

With the application of the formula (37), the two-dimensional impurity concentration distribution related to the Rₚ line 2 is represented as follows.

N_{R}_{_{—}}₂(s,u₂,v₂)=gₛ_{_{—}}_{b}(s,W,σₛ)fᵤ(u₂,d_{G},σᵤ)fᵥ(v₂) (54)

The variable transformation in this case is represented as follows.

$$\{ \begin{matrix}θ = \frac{π}{2} - α \\ x = s \\ y = {u}_{2} + ( H - {R}_{p} cos α + \frac{{d}_{G}}{2} ) \\ z = {v}_{2} - ( \frac{{L}_{G}}{2} - {R}_{p} sin α )\end{matrix} \qquad ( 55 )$$

With the application of the formula (37), the two-dimensional impurity concentration distribution related to the Rₚ line 3 is represented as follows.

N_{R0}_{_{—}}₃(s,u₃,v₃)=gₛ_{_{—}}_{b}(s,W,σₛ)fᵤ(u₂,L_{G}−Rₚ sin α,σᵤ)fᵥ(v₃) (56)

The variable transformation in this case is represented as follows.

$$\{ \begin{matrix}θ = α \\ x = s \\ y = - [ {v}_{3} - ( H - {R}_{p} cos α + {d}_{G} ) ] \\ z = {u}_{3} + \frac{{R}_{p} sin α}{2}\end{matrix} \qquad ( 57 )$$

With the application of the formula (37), the two-dimensional impurity concentration distribution related to the Rₚ line 4 is represented as follows.

$${N}_{R 0 \_ 4} ( s , {u}_{4} , {v}_{4} ) = {g}_{s \_ b} ( s , W , {σ}_{s} ) {f}_{u} ( {u}_{4} , G - \frac{{L}_{G}}{2} - ( {d}_{G} + {R}_{p} cos α ) tan α , {σ}_{u} ) {f}_{v} ( {v}_{3} ) \qquad ( 58 )$$

The variable transformation in this case is represented as follows.

$$\{ \begin{matrix}θ = α \\ x = s \\ y = - [ {v}_{4} - ( H - {R}_{p} cos α ) ] \\ z = {u}_{4} + \frac{G + \frac{{L}_{G}}{2} + ( {d}_{G} + {R}_{p} cos α ) tan α}{2}\end{matrix} \qquad ( 59 )$$

In any of the above cases, the following equations hold.

$$\{ \begin{matrix}{σ}_{v} = \sqrt{Δ {R}_{p}^{2} {cos}^{2} θ + Δ {R}_{pt}^{2} {sin}^{2} θ} \\ {σ}_{u} = \sqrt{Δ {R}_{pt}^{2} {cos}^{2} θ + Δ {R}_{p}^{2} {sin}^{2} θ} \\ {σ}_{s} = Δ {R}_{pt}\end{matrix} \qquad ( 60 )$$

According to the above description, the two-dimensional impurity concentration distribution N_{R0} for the rotation angle of 0° is obtained by the sum of the two-dimensional impurity concentration distributions N_{R0}_{_{—}}₁ to N_{R0}_{_{—}}₄ for the Rₚ lines 1 to 4, and thus is represented as follows.

N_{R0}(x,y,z)=N_{R0}_{_{—}}₁(x,y,z)+N_{R0}_{_{—}}₂(x,y,z)+N_{R0}_{_{—}}₃(x,y,z)+N_{R0}_{_{—}}₄(x,y,z) (61)

The two-dimensional impurity concentration distribution for the rotation angle of 180° is symmetrical with the above-described distribution with respect to the xy-plane with a z value of 0, and thus is represented as follows.

N_{R}_{_{—}}₁₈₀(x,y,z)=N_{R}_{_{—}}₀(x,y,−z) (62)

Accordingly, the three-dimensional impurity concentration distribution in the FinFET 50 is obtained on the basis of the respective two-dimensional impurity concentration distributions for the rotation angles of 0°, 90°, 180°, and 270°.

It is now assumed that the doping is performed with the structure parameters of the FinFET 50 set as a width W of 50 nm, a height H of 200 nm, and a gate length L_{G} of 0.1 μm, and with the ion implantation condition set as ions of As, acceleration energy of 30 keV, a dose of 1×10¹⁵ cm⁻², a tilt angle of 30°, and rotation angles of 90° and 270°. In this case, Rₚ, ΔRₚ, and ΔRₚₜ are 25.9 nm, 11.2 nm, and 11.0 nm, respectively.

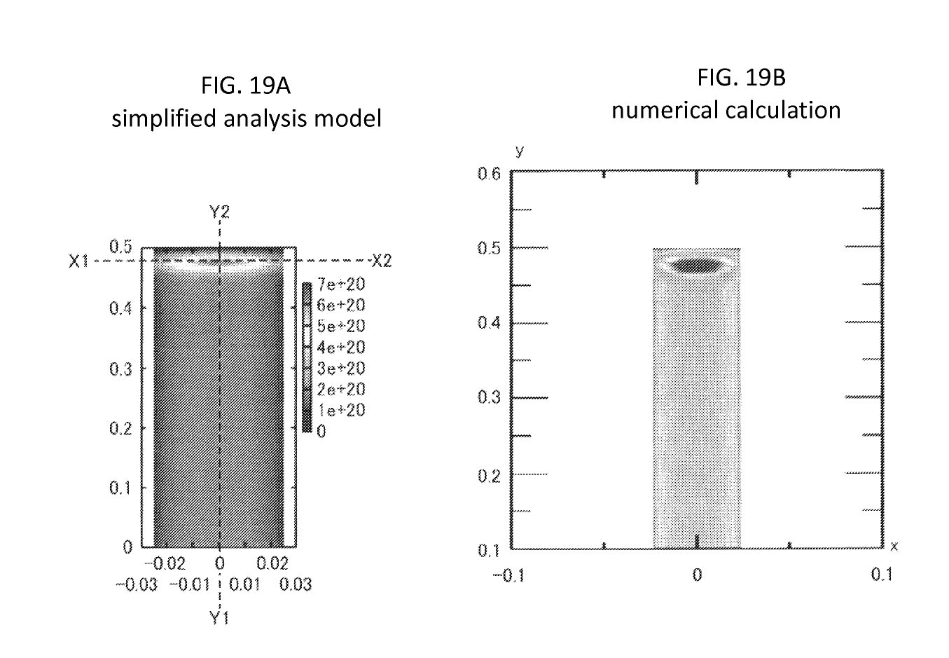

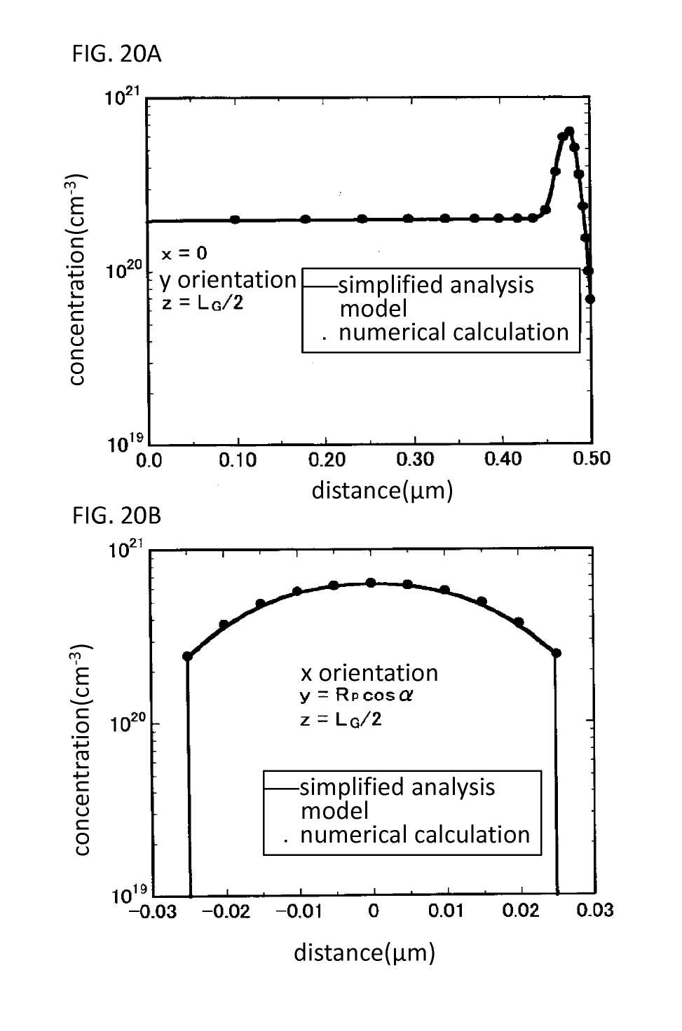

FIGS. 19A and 19B illustrate two-dimensional impurity concentration distributions on the xy-plane with a z value of L_{G}/2, i.e., at an end of the gate illustrated in FIG. 15. Further, FIGS. 20A and 20B illustrate the corresponding one-dimensional (1D) cut concentration distributions in the longitudinal direction and the transverse direction, respectively.

FIGS. 19A and 19B are diagrams illustrating two-dimensional impurity concentration distributions on the xy-plane at an end of the gate illustrated in FIG. 15. FIG. 19A illustrates the two-dimensional impurity concentration distribution obtained by the use of the simplified analysis model, and FIG. 19B illustrates the two-dimensional impurity concentration distribution obtained by numerical calculation. An upper portion of the channel has a high impurity concentration owing to the contributions by two side surfaces and the upper surface. The distribution of the simplified analysis model illustrated in FIG. 19A and the distribution of the numerical calculation illustrated in FIG. 19B match each other well.

Each of FIGS. 20A and 20B is a diagram illustrating a one-dimensional cut concentration distribution of a cross section of the two-dimensional impurity concentration distribution in FIG. 19A obtained by the use of the simplified analysis model. In FIGS. 20A and 20B, a solid line represents the distribution obtained by the simplified analysis model, and black dots represent the distribution obtained by the numerical calculation. FIG. 20A illustrates a longitudinal cross-sectional distribution along a line segment Y1-Y2 in the two-dimensional impurity concentration distribution illustrated in FIG. 19A. FIG. 20B illustrates a transverse cross-sectional distribution along a line segment X1-X2 in the two-dimensional impurity concentration distribution illustrated in FIG. 19A.

In the longitudinal one-dimensional cut concentration distribution illustrated in FIG. 20A, the peak of the impurity concentration appears on the Y2 side of the line segment Y1-Y2 in the two-dimensional impurity concentration distribution illustrated in FIG. 19A. The distribution obtained by the simplified analysis model and the distribution obtained by the numerical calculation match each other well.

The transverse one-dimensional cut concentration distribution illustrated in FIG. 20B indicates that the impurity concentration is the highest at the center owing to the contributions by both sides resulting from the respective ion implantations with the rotation angles of 90° and 270°. Also in this aspect, the distribution obtained by the simplified analysis model and the distribution obtained by the numerical calculation match each other well.

Subsequently, description will be made of simulation results of the two-dimensional impurity concentration distribution on the cross sections in the z-direction, i.e., on the zy-plane and the zx-plane.

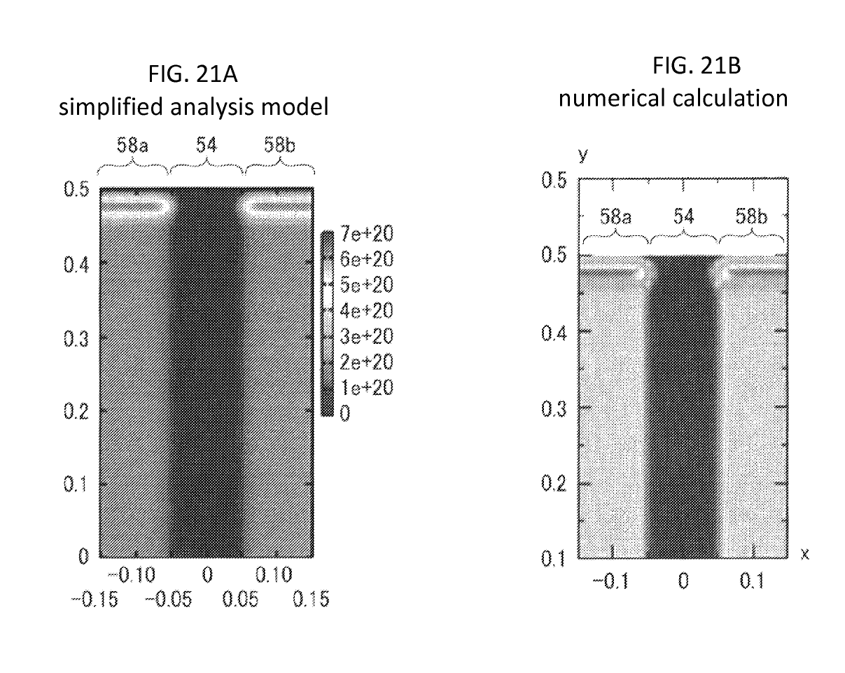

FIGS. 21A and 21B are diagrams illustrating two-dimensional impurity concentration distributions on the zy-plane of the FinFET 50 illustrated in FIG. 15. FIGS. 21A and 21B illustrate the two-dimensional impurity concentration distribution obtained by the use of the simplified analysis model and the two-dimensional impurity concentration distribution obtained by numerical calculation, respectively, to allow comparison therebetween in terms of the concentration distribution on the zy-plane (x=0). An upper portion of the channel has a high impurity concentration owing to the contributions by two side surfaces and the upper surface. The distribution of the simplified analysis model illustrated in FIG. 21A and the distribution of the numerical calculation illustrated in FIG. 21B match each other well.

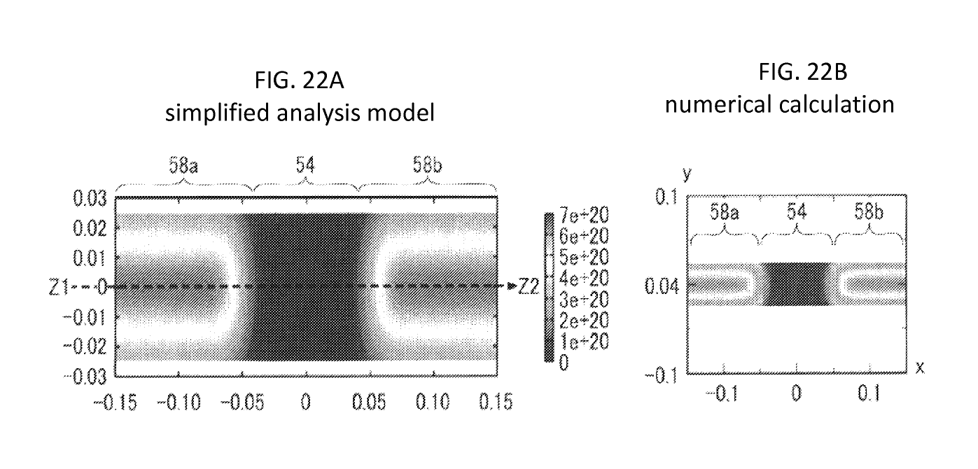

FIGS. 22A and 22B are top views illustrating two-dimensional impurity concentration distributions on the zx-plane of the FinFET 50 illustrated in FIG. 15 at a depth y of H−Rₚ cos α. FIGS. 22A and 22B illustrate the two-dimensional impurity concentration distribution obtained by the use of the simplified analysis model and the two-dimensional impurity concentration distribution obtained by numerical calculation, respectively, to allow comparison therebetween in terms of the concentration distribution on the zx-plane. The impurity concentration increases toward an x value of 0 in both the source region 58a and the drain region 58b. The distribution of the simplified analysis model illustrated in FIG. 22A and the distribution of the numerical calculation illustrated in FIG. 22B match each other well.

As illustrated in FIGS. 21A and 21B and FIGS. 22A and 22B, it is indicated that, in the FinFET structure, the concentration naturally increases in a region near the surface thereof and the penetration in the region also increases. That is, the distribution is not equal in the y-direction. The penetration from the source region 58a and the drain region 58b into the channel is well expressed by both the simplified analysis model and the numerical calculation.

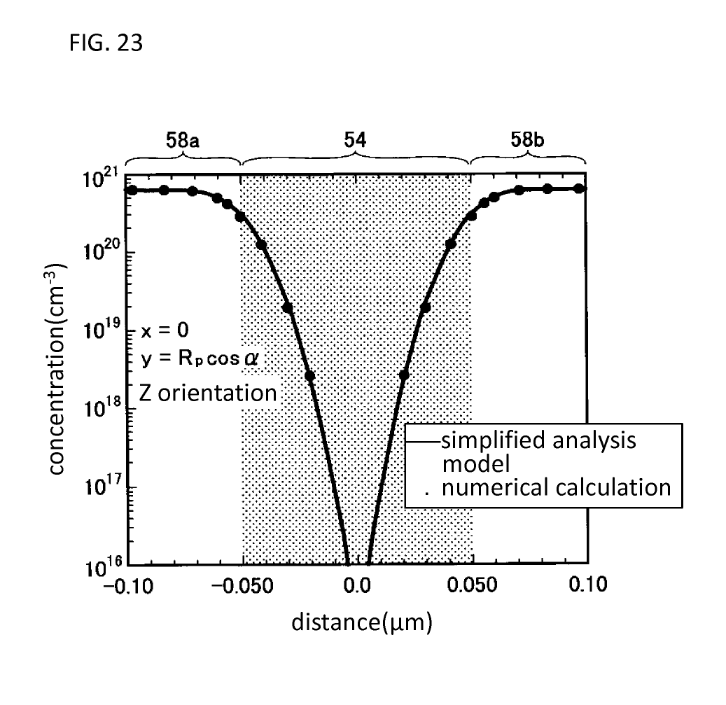

FIG. 23 is a diagram illustrating a one-dimensional cut concentration distribution of a cross section of the two-dimensional impurity concentration distribution of FIG. 22A obtained by the use of the simplified analysis model. FIG. 23 illustrates a transverse cross-sectional distribution along a line segment Z1-Z2 in the two-dimensional impurity concentration distribution illustrated in FIG. 22A, which is a one-dimensional distribution from a depth of H−Rₚ cos α to a depth of H/2. In FIG. 23, solid lines represent the distribution obtained by the simplified analysis model, and black dots represent the distribution obtained by the numerical calculation.

The one-dimensional cut concentration distribution illustrated in FIG. 23 indicates a phenomenon in which the impurity concentration is high between the gate electrode 54 and a side surface of the source region 58a or the drain region 58b, and in which the impurity concentration in the gate electrode 54 is abruptly reduced toward the center (z=0). Also in this case, the phenomenon is well expressed by both the simplified analysis model and the numerical calculation.

### Simulator Configuration Example

Description will be made of a simulator configuration for realizing, irrespective of the above-described shape of the semiconductor device, the two-dimensional impurity concentration distribution and three-dimensional impurity concentration distribution resulting from the ion implantation.

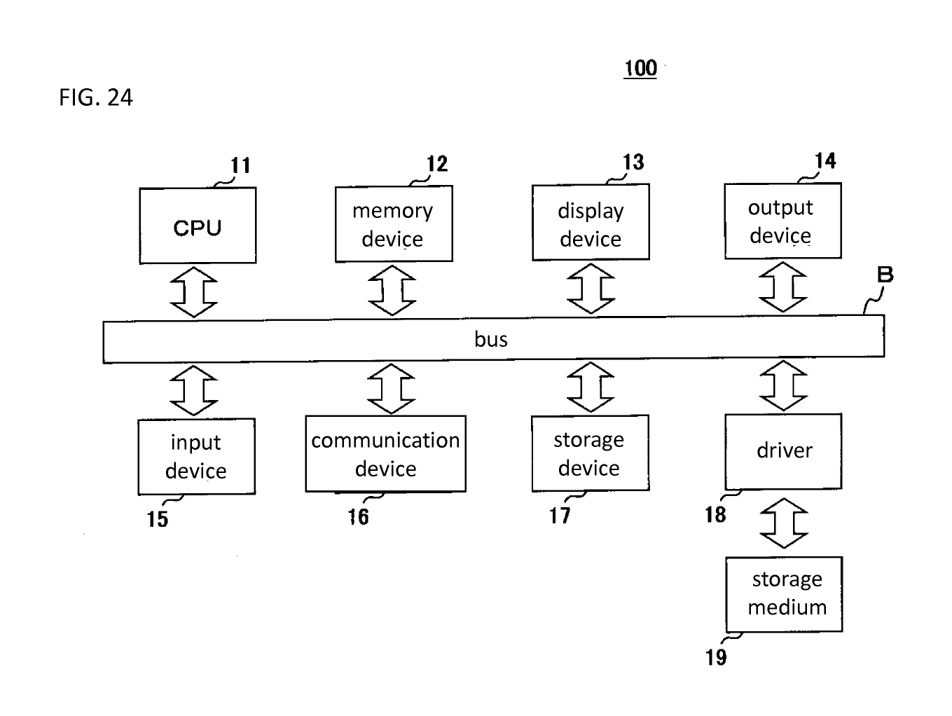

FIG. 24 is a diagram illustrating a hardware configuration of a simulator. A simulator 100 illustrated in FIG. 24, which is a device controlled by a computer, includes a CPU (Central Processing Unit) 11, a memory unit 12, a display unit 13, an output unit 14, an input unit 15, a communication unit 16, a storage device 17, and a driver 18, which are connected to a system bus B.

The CPU 11 controls the simulator 100 in accordance with a program stored in the memory unit 12. A RAM (Random Access Memory), a ROM (Read-Only Memory), and the like are used for the memory unit 12, which stores, for example, programs executed by the CPU 11, data requested for the processing by the CPU 11, and data obtained through the processing by the CPU 11. Further, a part of the area of the memory unit 12 is allocated as a work area for use in the processing by the CPU 11.

The display unit 13 displays a variety of requested information under the control of the CPU 11. The output unit 14, which includes a printer and so forth, is used to output a variety of information in accordance with an instruction from a user. The input unit 15, which includes a mouse, a keyboard, and so forth, is used to allow the user to input a variety of information requested for the processing of the simulator 100. The communication unit 16 is a device connected to, for example, the Internet, a LAN (Local Area Network), or the like to control communication with an external device. The storage device 17, which uses a hard disk unit, for example, stores data such as a program for performing a variety of processes.

A program realizing the processing performed by the simulator 100 is provided to the simulator 100 by a storage medium 19, such as a CD-ROM (Compact Disc Read-Only Memory), for example. That is, as the storage medium 19 storing the program is set in the driver 18, the driver 18 reads the program from the storage medium 19, and the read program is installed in the storage device 17 via the system bus B. Then, upon start of the program, the CPU 11 starts the processing thereof in accordance with the program installed in the storage device 17. The medium storing the program is not limited to the CD-ROM, and may be any computer-readable medium.

The program realizing the processing according to the first and second embodiments may also be downloaded by the communication unit 16 through a network and installed in the storage device 17. Further, if the simulator 100 supports USB (Universal Serial Bus), the program may be installed from a USB-connectable external storage device. Further, if the simulator 100 supports flash memory, such as an SD (Secure Digital) card, the program may be installed from such a memory card.

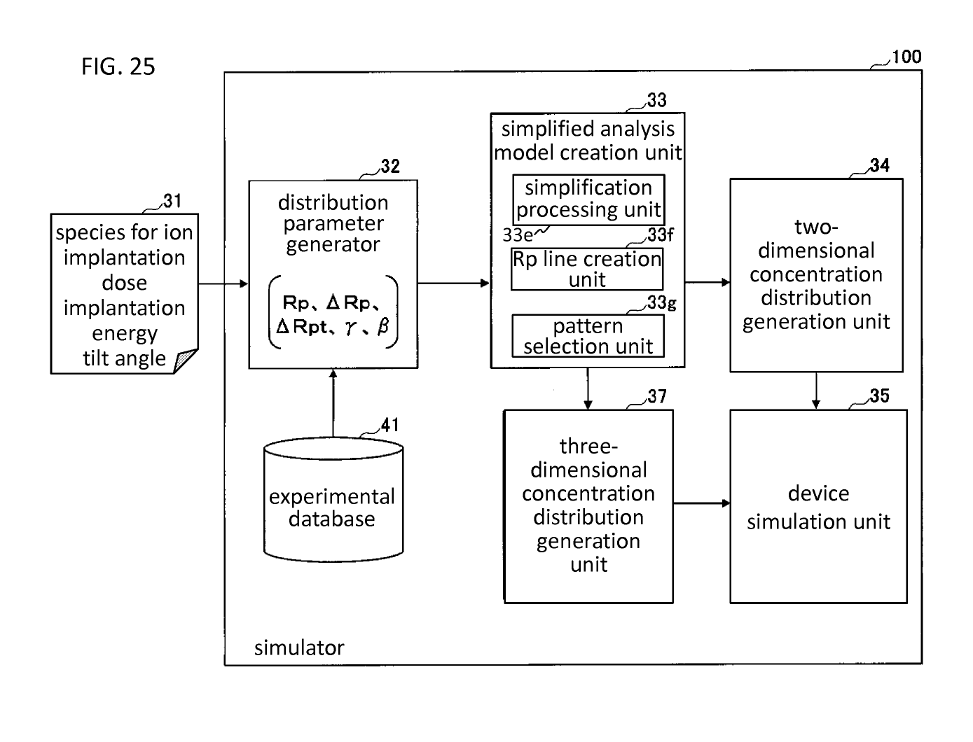

FIG. 25 is a diagram illustrating a functional configuration example of the simulator 100. In FIG. 25, the simulator 100 includes a distribution parameter generation unit 32, a simplified analysis model creation unit 33, a two-dimensional concentration distribution generation unit 34, a device simulation unit 35, and a three-dimensional concentration distribution generation unit 37.

The distribution parameter generation unit 32 is a processing unit which generates, in accordance with the input of an ion implantation condition 31 and with the use of an experimental database 41, the range projection Rₚ of the ion implantation, the straggling ΔRₚ of the range projection in the depth direction, the straggling ΔRₚₜ of the range projection in the transverse direction, and high-order moments γ and β. The ion implantation condition 31 specifies the implantation ion, the substrate type, the implantation energy, the dose, the tile angle, and so forth. The experimental database 41 stores a table which includes distribution parameters according to the implantation energy associated with respective combinations of the implantation ion and the substrate type.

The simplified analysis model creation unit 33 includes a simplification processing unit 33e, an Rₚ line creation unit 33f, and a pattern selection unit 33g. The simplification processing unit 33e is a processing unit which realizes a simplified analysis model capable of illustrating the pocket ion implantation distribution in the region b and the region a combining the regions a₁ and a₂ illustrated in FIGS. 2A to 2C. The Rₚ line creation unit 33f is a processing unit which draws the Rₚ lines each representing the range projection Rₚ in a surface of a device subjected to the ion implantation and calculates the pocket ion implantation distribution in accordance with the Rₚ lines. The pattern selection unit 33g is a processing unit which, in order to support the three-dimensional model, selects one of the Rₚ lines in the horizontal direction s in the patterns a, b, c, and d illustrated in FIGS. 14A to 14D and calculates the impurity concentration distribution resulting from the ion implantation into the pocket region 5.

The simplified analysis model creation unit 33 further includes a calculation processing unit for calculating the impurity concentration distribution resulting from the ion implantation into each of the substrate, the channel region, the extension region, and the source and drain regions. The drawing, however, only illustrates the processing units concerning the present embodiment of the pocket ion implantation distribution, and omits the illustration of other components.

The two-dimensional concentration distribution generation unit 34 is a processing unit which performs numerical calculation to calculate, for each of the ion beams 9 and in accordance with the mesh size on the xy-plane, the ion implantation concentration in the substrate applied with the ion beams 9, to thereby generate a two-dimensional concentration distribution resulting from the ion implantation.

The device simulation unit 35 is a processing unit which evaluates an electrical characteristic by generating the corresponding distribution parameter from the ion implantation condition 31.

The three-dimensional concentration distribution generation unit 37 is a processing unit which performs numerical calculation to calculate, for each of the ion beams 9 and in accordance with the mesh size on the xyz-plane, the ion implantation concentration in the substrate applied with the ion beams 9, to thereby generate a three-dimensional concentration distribution resulting from the ion implantation.

The two-dimensional concentration distribution generation unit 34 and the three-dimensional concentration distribution generation unit 37 receive from the simplified analysis model creation unit 33 the Rₚ lines each representing the shape and the peak concentration position of the impurity concentration distribution in each of the steps of the ion implantation process, and thus may be integrated into one processing unit.

The distribution parameter generation unit 32, the simplified analysis model creation unit 33, the two-dimensional concentration distribution generation unit 34, and the device simulation unit 35 operate as a two-dimensional process device simulator which verifies an electrical characteristic on the basis of the two-dimensional concentration distribution, and also operate as a two-dimensional inverse modeling simulator which verifies the two-dimensional concentration distribution on the basis of a desired electrical characteristic and optimizes the two-dimensional concentration distribution.

Further, the distribution parameter generation unit 32, the simplified analysis model creation unit 33, the three-dimensional concentration distribution generation unit 37, and the device simulation unit 35 operate as a three-dimensional process device simulator which verifies an electrical characteristic on the basis of the three-dimensional concentration distribution, and also operate as a three-dimensional inverse modeling simulator which verifies the three-dimensional concentration distribution on the basis of a desired electrical characteristic and optimizes the three-dimensional concentration distribution.

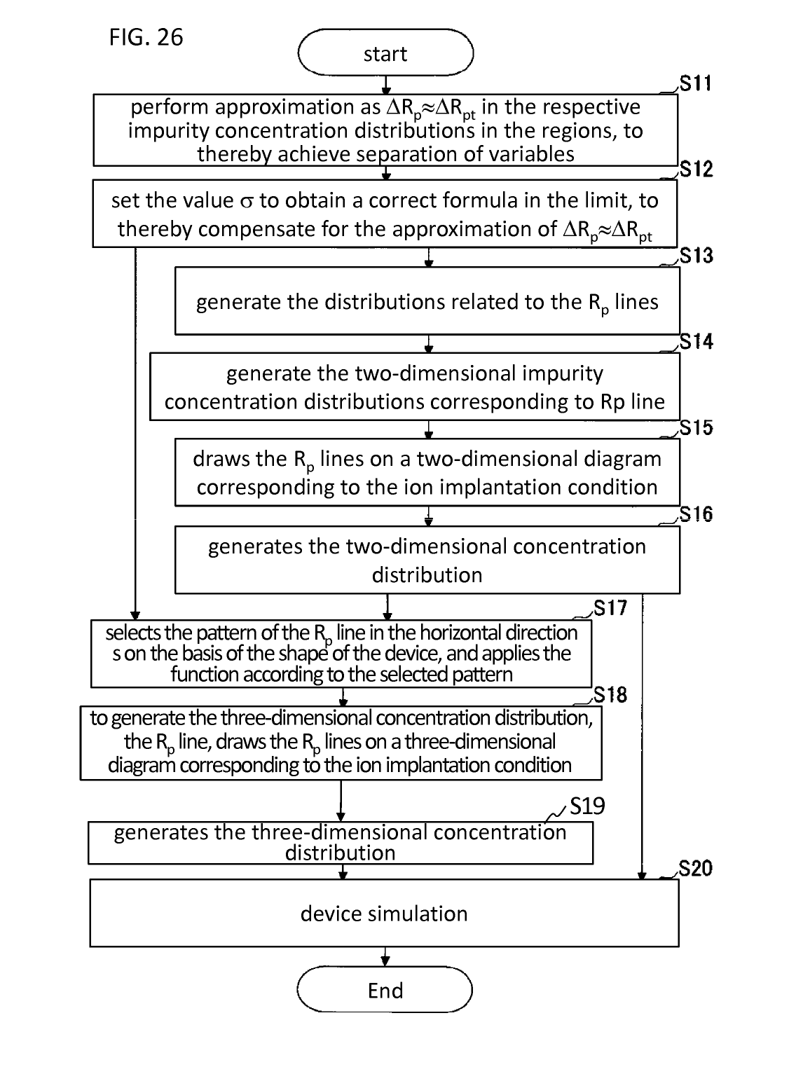

Subsequently, with reference to FIG. 26, description will be made of the calculation process performed by the simplified analysis model creation unit 33 to calculate the impurity concentration distribution resulting from the ion implantation into the pocket region 5. FIG. 26 is a diagram for explaining the calculation process of calculating the impurity concentration distribution in a pocket region using the simplified analysis model.

In FIG. 26, the simplified analysis model creation unit 33 causes the simplification processing unit 33e to perform approximation as ΔRₚ≈ΔRₚₜ in the respective impurity concentration distributions in the regions a₁, a₂, and b for simplification in the longitudinal direction (depth direction), to thereby achieve separation of variables (Step S11). At Step S11, the regions a₁ and a₂ are represented as the single region a, and the impurity concentration distribution formula (23) therefor is derived. Further, the impurity concentration distribution formula (28) for the region b is derived.

Then, the simplification processing unit 33e sets the value σ to obtain a correct formula in the limit, to thereby compensate for the approximation of ΔRₚ≈ΔRₚₜ (Step S12). At Step S12, the value σ in the longitudinal direction and the value σ in the transverse direction are replaced by σ₁ and σ₂, respectively, in the respective impurity concentration distribution formulae (23) and (28) for the regions a and b. Thereby, the formulae (26) and (29) are derived.

Then, to generate the two-dimensional concentration distribution resulting from the ion implantation, Steps S13 to S16 and Step S20 are performed. Meanwhile, to generate the three-dimensional concentration distribution resulting from the ion implantation, Steps S17 to S20 are performed.

The Rₚ line creation unit 33f generates the distributions related to the Rₚ lines (Step S13). If the Rₚ lines are approximated with semi-infinite straight lines, the Rₚ line creation unit 33f generates the two-dimensional impurity concentration distributions corresponding thereto (Step S14). The impurity concentration distribution formula (39) is applied at Step S13, and the impurity concentration distribution formula (38) is applied at Step S14.

To generate the two-dimensional concentration distribution, the Rₚ line creation unit 33f draws the Rₚ lines on a two-dimensional diagram corresponding to the ion implantation condition (Step S15). For example, the Rₚ lines 12-1, 12-2, and 12-3 as illustrated in FIG. 12 are drawn.

As for the pocket ion implantation distribution, the two-dimensional concentration distribution generation unit 34 generates, in accordance with the Rₚ lines drawn on the two-dimensional diagram and with the use of the impurity concentration distribution formula (39) or (38) to be applied, the two-dimensional concentration distribution by performing numerical calculation, and also generates the two-dimensional concentration distribution for each of the other steps of the ion implantation process (Step S16).

In the simulation of the two-dimensional concentration distribution, Steps S17 to S19 are omitted, and the electrical characteristic evaluation by the device simulation unit 35 is performed with the use of the result of the two-dimensional concentration distribution (Step S20).

Further, to generate the three-dimensional concentration distribution, the pattern selection unit 33g of the simplified analysis model creation unit 33 selects the pattern of the Rₚ line in the horizontal direction s on the basis of the shape of the device, and applies the function according to the selected pattern (Step S17). That is, the pattern selection unit 33g selects, for each of the angles for ion implantation, one pattern according to the shape of the device from the patterns a to d illustrated in FIGS. 14A to 14D, and applies one of the equations of the formula (41) as the function according to the selected pattern.

Then, to generate the three-dimensional concentration distribution, the Rₚ line creation unit 33f draws the Rₚ lines on a three-dimensional diagram corresponding to the ion implantation condition (Step S18). For example, the Rₚ lines 1 to 3 as illustrated in FIG. 17 and the Rₚ lines 1 to 4 as illustrated in FIG. 18 are drawn.

As for the pocket ion implantation distribution, in accordance with the Rₚ lines drawn on the three-dimensional diagram and with the use of the impurity concentration distribution formula to be applied, the three-dimensional concentration distribution generation unit 37 generates, for each of the rotation angles, the three-dimensional concentration distribution by performing numerical calculation, and also generates the three-dimensional concentration distribution for each of the other steps of the ion implantation process (Step S19). As for the pocket ion implantation distribution, the formulae (50), (51), (61), and (62) are applied for the rotation angles of 90°, 270°, 0°, and 180°, respectively.

Then, with the use of the result of the three-dimensional concentration distribution, the electric characteristic evaluation by the device simulation unit 35 is performed (Step S20).

The above-described embodiments allows the first introduction of a simplified analysis model of the pocket ion implantation distribution. Further, it is possible to realize substantially the same accuracy as the accuracy obtained by numerical calculation, and to obtain a physical image. Further, the embodiments are capable of flexibly following the device structure, and automatically generating the two- and three-dimensional impurity concentration distributions according to the device structure.

The present embodiments are not limited to the specifically disclosed embodiments, and may be modified or altered in various ways without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. An ion implantation distribution generation method for causing a computer to generate an ion implantation distribution, the method causing the computer to perform:
generating distributions related to Rₚ lines each representing a range projection Rₚ in a surface subjected to ion implantation in a device structure of a semiconductor integrated circuit;
drawing the Rₚ lines on a two-dimensional diagram corresponding to an ion implantation condition; and
generating, for each of the Rₚ lines, a two-dimensional impurity concentration distribution in accordance with two-dimensional vector coordinates provided to the Rₚ line.

2. The ion implantation distribution generation method according to claim 1, wherein the two-dimensional impurity concentration distribution is generated by using of formula (63)
$$N ( u , v ) = \frac{1}{2} erfc ( \frac{u}{\sqrt{2} {σ}_{u}} ) \times \frac{Φ cos θ}{\sqrt{2 π} {σ}_{v}} exp [ - \frac{{v}^{2}}{2 {σ}_{v}^{2}} ] \qquad ( 63 )$$
wherein v and u respectively represent a unit vector in a vertical direction and a unit vector in a horizontal direction with respect to a plane, and the direction from an implanted region to an unimplanted region corresponds to a positive direction, and
wherein θ represents an angle relative to a vertical direction with respect to the plane.

3. The ion implantation distribution generation method according to claim 2, the method causing the computer to further perform:
selecting, on basis of the presence or absence of contribution of the ion implantation in the device structure, the pattern of the Rₚ line in another horizontal direction s different from the horizontal direction u in a three-dimensional diagram;
drawing the Rₚ lines on the three-dimensional diagram corresponding to the ion implantation condition; and
generating, for each of the Rₚ lines, a three-dimensional impurity concentration distribution by using the formula (63) in accordance with two-dimensional vector coordinates provided to the Rₚ line.

4. The ion implantation distribution generation method according to claim 3, wherein in the drawing the Rₚ lines on the three-dimensional diagram corresponding to the ion implantation condition, a function according to the pattern selected in selecting the pattern of the Rₚ line in another horizontal direction s different from the horizontal direction u in a three-dimensional diagram is used.

5. The ion implantation distribution generation method according to claim 1, the method causing the computer to further perform:
when generating an ion implantation distribution at a high tilt angle, simplifying a shape of the impurity concentration distribution in each of ion implantation distribution regions, which have different influences on a channel region in accordance with the gate structure, by approximating variations in a longitudinal direction and variations in a transverse direction; and
compensating for the approximation of the variations in the longitudinal direction and the variations in a transverse direction so as to obtain a correct shape in the limit in an unshadowed region of the ion implantation distribution regions.

6. The ion implantation distribution generation method according to claim 5, the method causing the computer to further perform:
performing device simulation for evaluating an electrical characteristic of the device structure of the semiconductor integrated circuit on the basis of the two-dimensional impurity concentration distribution or the three-dimensional impurity concentration distribution.

7. The ion implantation distribution generation method according to claim 4, the method causing the computer to further perform:
performing inverse modeling for generating the two-dimensional impurity concentration distribution or the three-dimensional impurity concentration distribution corresponding to a desired electrical characteristic.

8. The ion implantation distribution generation method according to claim 1, wherein the semiconductor integrated circuit is a metal oxide semiconductor field effect transistor or a fin field effect transistor.

9. A computer-readable storage medium for storing a computer-executable program for causing a computer to function as a simulator which generates an ion implantation distribution, the program causing the computer to perform:
generating distributions related to Rₚ lines each representing a range projection Rₚ in a surface subjected to ion implantation in a device structure of a semiconductor integrated circuit;
drawing the Rₚ lines on a two-dimensional diagram corresponding to an ion implantation condition; and
generating, for each of the Rₚ lines, a two-dimensional impurity concentration distribution in accordance with two-dimensional vector coordinates provided to the Rₚ line.

10. A process device simulator for evaluating an electrical characteristic by using an ion implantation distribution, the simulator comprising:
means for generating distributions related to Rₚ lines each representing a range projection Rₚ in a surface subjected to ion implantation in a device structure of a semiconductor integrated circuit;
means for drawing the Rₚ lines on a two-dimensional diagram or a three-dimensional diagram corresponding to an ion implantation condition;
means for generating, for each of the Rₚ lines, a two-dimensional impurity concentration distribution or a three-dimensional impurity concentration distribution in accordance with two-dimensional vector coordinates provided to the Rₚ line; and
means for performing device simulation for evaluating the electrical characteristic of the device structure of the semiconductor integrated circuit on the basis of the two-dimensional impurity concentration distribution or the three-dimensional impurity concentration distribution.

11. The process device simulator according to claim 10, wherein the process device simulator is configured to optimize the impurity concentration distribution corresponding to a desired electrical characteristic.
